(19) United States
(12) Patent Application Publication
(10) Pub. No.: US 2010/0280855 A1
(43) Pub. Date: Nov. 4, 2010

(54) Management of a first stand-alone system used as a subsystem within a second system

(76) Inventor: Vinay Gupta, San Jose, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/387,358

(22) Filed: Apr. 30, 2009

(51) Int. Cl. G06Q 50/00; G06F 9/54; G06Q 10/00; G06F 7/00

(52) U.S. Cl. 705/7; 719/318; 713/2; 719/328

(57) ABSTRACT

Embodiments of the present invention are directed to management of stand-alone systems that are included in larger, complex systems as components or subsystems. Embodiments of the present invention use pre-existing functionality of stand-alone-system components for managing the stand-alone-system components within the context of managing the complex systems that include them. One approach common to many embodiments of the present invention is to manage the stand-alone-system subsystems, using the management interface of the complex systems that include them, as components of the complex systems.

### TECHNICAL FIELD

The present invention is related to systems design and engineering, distributed computing, and system administration, and, in particular, to methods and systems for managing complex, multi-processor, multi-component computer systems.

### BACKGROUND OF THE INVENTION

Initially, computer systems were completely isolated, monolithic systems that included a single processor and a relatively small number of essential peripheral devices, including card readers, teletype machines, and magnetic tape devices. Computer hardware, computer-systems architecture, and computer software control have evolved tremendously during the past 60 years. Processing power, memory densities, mass-storage-device capacities, communications bandwidths, and many other fundamental parameters of computer hardware and computer systems have increased at least geometrically over the span of many years. Consumers today can purchase, for less than $1,000, desktop personal computer systems that exceed, in processing power, memory size, and mass-storage capacity, supercomputers of previous generations. As the capacities, speeds, bandwidths, and densities of components and systems have increased, and as the cost of systems have decreased, the cost-benefit tradeoffs and balances in system design have, in many cases, changed considerably over the past several decades. Whereas it once may have been cost-effective and time-efficient to engineer and produce special-purpose subsystems, components, and devices for inclusion in larger computer systems, it is presently often more cost effective and time-efficient to use already developed systems as subsystems and components in larger, complex systems, even in the case that only a small portion of the functionality or capacity of these subsystems, components, and devices are needed. Large academic distributed computing systems that use thousands of aging, nearly obsolete personal computers networked together to produce high-computational bandwidth and parallel, distributed computer systems are an example of complex systems that employ stand-alone systems as components. Many of the components and built-in functionality of the obsolescent personal computers in such massively distributed systems are neither needed nor used in the parallel, distributed computing system, but the processing bandwidth of the obsolete personal computers is obtained both cost effectively and time efficiently when compared to the cost and time that would be expended to engineer and produce such systems using new, special-purpose hardware components.

Using existing systems as components of larger systems, as in the case of academic parallel, distributed computing systems built from thousands of obsolete personal computers, may be both cost effective and time efficient, but may also present various challenges and problems different from those encountered in systems built from special-purpose components. Designers and developers of such complex systems, as well as manufacturers, vendors, and ultimately users of such systems, therefore continue to seek cost-effective and time-effective approaches for utilizing existing systems in new, larger, complex systems that incorporate them.

### BRIEF DESCRIPTION OF THE DRAWINGS

FIG. 1 illustrates a complex computational system.

FIG. 2 illustrates the complexity of a multi-server enclosure within a complex distributed system, such as that shown in FIG. 1.

FIG. 3 illustrates the logical structure of a server blade.

FIG. 4 illustrates the software-control structure associated with each server blade of a multi-server enclosure.

FIGS. 5A-F illustrate general network communications and the use of network subsystems within complex computational systems.

FIG. 6 illustrates communications interconnections within a multi-server enclosure, such as that shown in FIG. 2.

FIG. 7 illustrates the general management interface of a complex computational system, such as the multi-server enclosure shown in FIG. 2 and discussed with reference to FIG. 6.

FIG. 8 illustrates the general approach for internal management of the multi-server enclosure discussed above with reference to FIGS. 2, 6, and 7.

FIGS. 9A-D illustrate various approaches to managing stand-alone systems used as components and subsystems within a larger computational system, including an approach used in embodiments of the present invention.

FIG. 10 illustrates one feature of certain stand-alone systems, such as servers, that can be exploited by the system console component of a complex computational system for system-management purposes.

FIG. 11 provides a control-flow diagram for the boot routine within a console program of a console component of a complex computational system that includes stand-alone systems as subsystems or components.

FIG. 12 is a control-flow diagram for a configure-for-health-monitoring routine within a console program of a complex computational system that includes stand-alone systems as subsystems or components.

FIG. 13 shows a control-flow diagram for configuring, for event monitoring, components of a complex computational system that includes stand-alone systems as subsystems for components.

FIG. 14 is a control-flow diagram for a monitoring routine within a console program of a complex computational system that includes stand-alone systems as subsystems or components.

FIGS. 15A-E illustrate a complex-system management interface that provides management of a complex computational system that includes stand-alone systems as subsystems or components according to one embodiment of the present invention.

FIGS. 16A-C illustrate three exemplary tables of a relational database used to implement a data-driven complex-system management interface according to one embodiment of the present invention.

FIGS. 17-18 illustrate, for a specific complex system, the type of information and parameters associated with two high-level system-management commands according to one embodiment of the present invention.

FIGS. 19A-C provide control-flow diagrams for portions of a complex-system management interface configuration interface that allows system administrators and other users to update, change, and otherwise configure a data-driven, complex-system management interface that represents one embodiment of the present invention.

FIGS. 20A-B provide control-flow diagrams for a routine “execute task” that constructs high-level command user-interface windows to select management tasks to which information is obtained from users and that uses this information to direct target-specific commands to embedded systems according to one embodiment of the present invention.

FIG. 21 illustrates a relational table “Event Registry” used in one embodiment of the present invention.

FIGS. 22A-C illustrate control-flow diagrams for event-filtering and event-reporting routines according to one embodiment of the present invention.

FIG. 23 shows code within a console program used to configure event detection on a stand-alone-system component of a complex system according to one embodiment of the present invention.

FIG. 24 shows code for detecting events on a stand-alone-system component of a complex system according to one embodiment of the present invention.

FIG. 25 shows code within a console program used to boot a stand-alone-system component of a complex system according to one embodiment of the present invention.

### DETAILED DESCRIPTION OF THE INVENTION

As discussed above, it is often more cost efficient and time efficient to use pre-existing stand-alone systems as components of larger systems, rather than designing and manufacturing the subsystems de novo for specific application within the complex systems. However, use of stand-alone systems as subsystems or components of larger, more complex systems may result in new and different challenges and problems, which embodiments of the present invention are intended to meet and solve.

Embodiments of the present invention are directed to management of complex systems that incorporate stand-alone systems as subsystems and/or components. Embodiments of the present invention use, where possible, pre-existing functionality of stand-alone-system components for managing the stand-alone-system components within the context of managing the complex systems that include them. One approach common to many embodiments of the present invention is to manage the stand-alone-system subsystems, using the management interface of the complex systems that include them, as components of the complex systems.

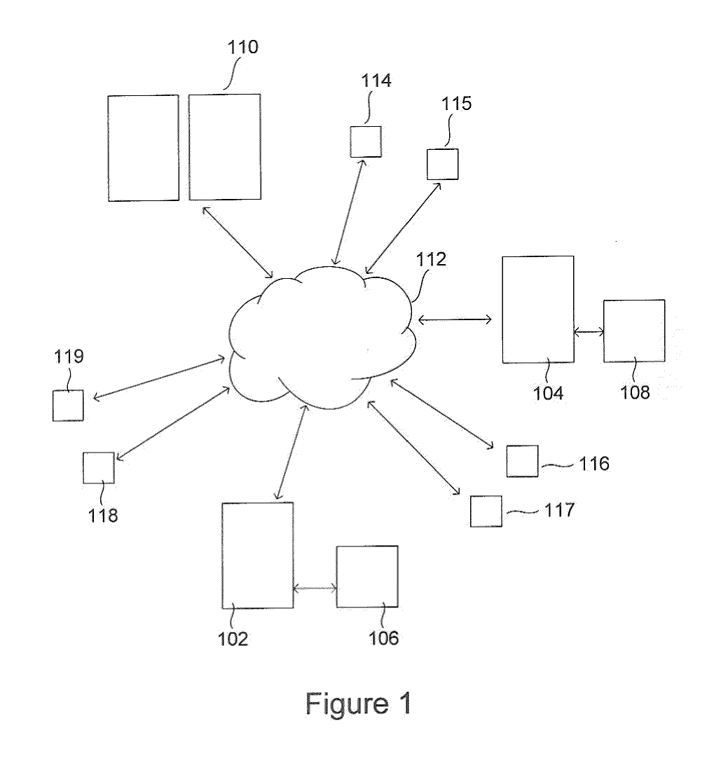

FIG. 1 illustrates a complex, distributed computational system. The complex, distributed computational system includes large, multi-server systems, such as systems 102 and 104, each with relatively large-capacity attached storage systems 106 and 108. The complex, distributed computational system may include additional storage systems or mainframe computers 110, and may be accessed, through a network 112, by hundreds or thousands of different users on personal computers or small-computer systems 114-119. Distributed computational systems, such as that shown in FIG. 1, may be linked together through high-bandwidth communications media to form even larger, widely distributed systems. Even at the abstract level shown in FIG. 1, it is apparent that the distributed computational systems is complex, generally using multiple different types of interconnection media, many different communications protocols, and a host of distributed-system control programs and logic to coordinate activities of the separate, different component systems.

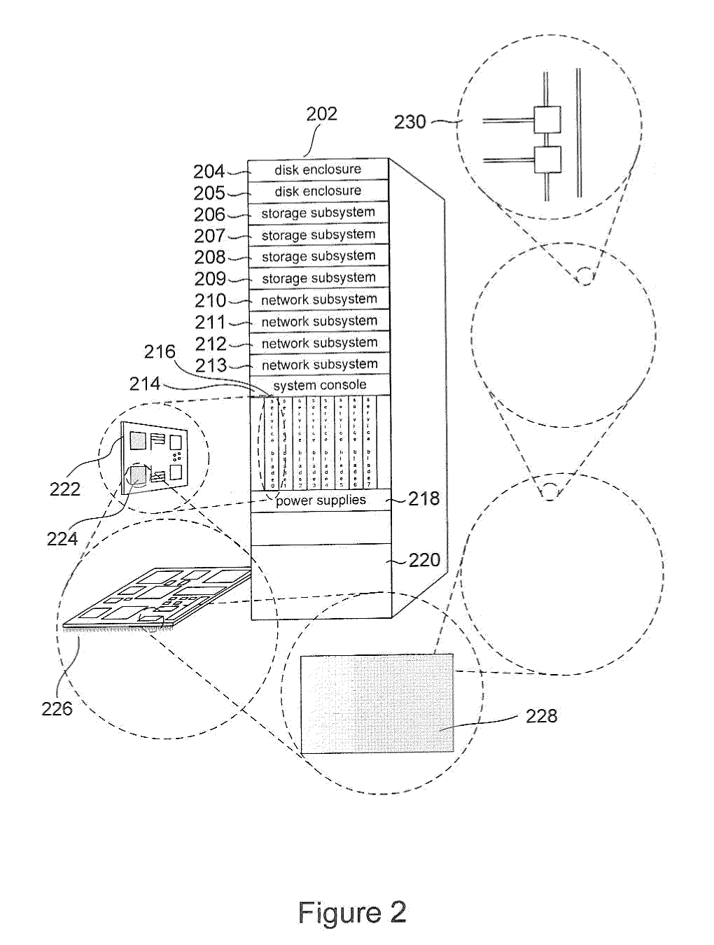

FIG. 2 illustrates the complexity of a multi-server enclosure within a complex distributed system, such as that shown in FIG. 1. The multi-server enclosure 202 includes disk enclosures 204-205, each of which contains multiple disk drives, a number of storage subsystems 206-209, each of which includes processors and storage-communications-media controllers for accessing local and remote storage devices, a number of network subsystems 210-213, each of which includes processors and communications-media controllers for sending and receiving data through one or more different communications media, including wide-area-network communications media, local-area-network communications media, the telephone system, and other communications media, a system-console component 214, a relatively large number of server blades, such as server blade 216, power supplies 218, and a complex, uninterruptable power supply 220.

Each server blade in the multi-server enclosure, such as server blade 216, includes a large server board 222 containing multiple processors, each processor, such as processor 224, a complex integrated circuit with multiple modules 226. When viewed at higher magnification, each integrated-circuit module is revealed to be a dense array 228 of logic-circuit cells which, at much higher magnification, include basic submicroscale and nanoscale circuit elements, including signal lines, transistors, and other circuit components 230. Thus, the complexity of a single multi-server enclosure, itself a single component of a larger distributed computational system, spans multiple complex components interconnected through internal and external communications media and extends, within individual components, down to nanoscale levels. Each component of the multi-server enclosure shown in FIG. 2 contains tens to hundreds of internal components. The design and manufacturing of each component involves significant engineering effort and testing. Clearly, when existing components can be used, significant cost and time efficiencies can be realized.

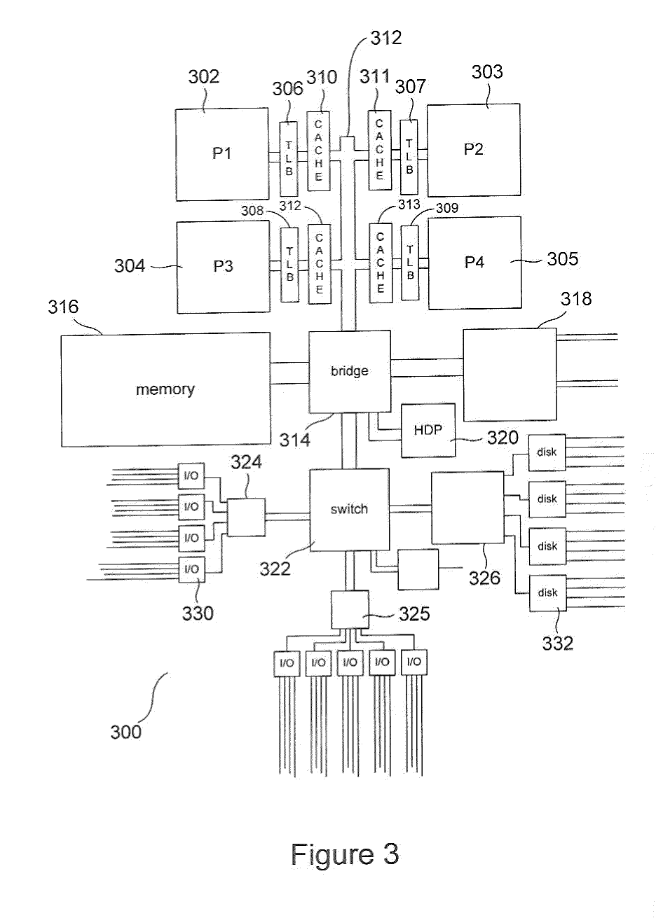

FIG. 3 illustrates the logical structure of a server blade. The server blade includes four processors 302-305, each associated with a translation lookaside buffer (“TLB”) and one or more memory caches 306-309 and 310-313, respectively. All four processors are interconnected through a high-speed bus 312 to a bridge device 314 that interconnects the processor bus with memory 316, a graphics processor 318, a hardware-dependent processor 320, and a switch device 322 through which processors and memory are interconnected to various high-level I/O busses or high-speed serial links 324-326. Each of the various components shown in FIG. 3, including a variety of I/O controllers, such as I/O controller 330, and disk controllers, such as disk controller 332, are themselves complex devices that would require many levels of hierarchical diagrams to describe. The memory 316 shown in FIG. 3 generally consists of many separate memory integrated circuits that are electrically interconnected and accessed through a memory controller.

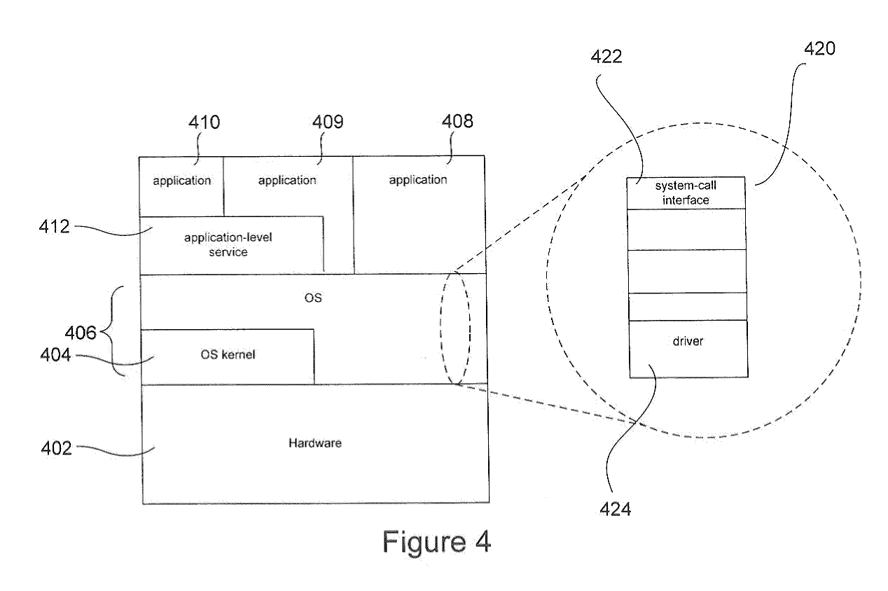

FIG. 4 illustrates the software-control structure associated with each server blade of a multi-server enclosure. In general, a hardware layer 402, corresponding to the processor, provides a hardware interface to layers of software that run on the processor. The hardware interface consists of an instruction set and many different hardware registers. An operating-system kernel 404 generally interfaces directly with privileged instructions and privileged registers. The operating-system kernel is generally a small part of an operating system 406 that provides an execution environment for one or more application programs 408-410 and application-level-service programs, such as database management systems 412. Each of the layers 404, 406, 408-410, and 412 in FIG. 4 consists of tens to hundreds to thousands of discrete modules and routines, often hierarchically organized. For example, the operating system 406 generally provides a hierarchically structured set of routines 420 that provide, to application programs, an interface to a low-level hardware device. The top-level routine 422 provides a system-call interface for application programs and the bottom routine 424 is a device driver that interfaces directly to a device controller for the hardware device. The set of routines 420, for example, provide an I/O interface for application routines that allow application routines to write data to, and read data from, a disk drive. Similar hierarchically organized sets of routines provide interfaces to network communications and access, by application programs through system interfaces, to a variety of different peripheral devices and functional features of the underlying computer system.

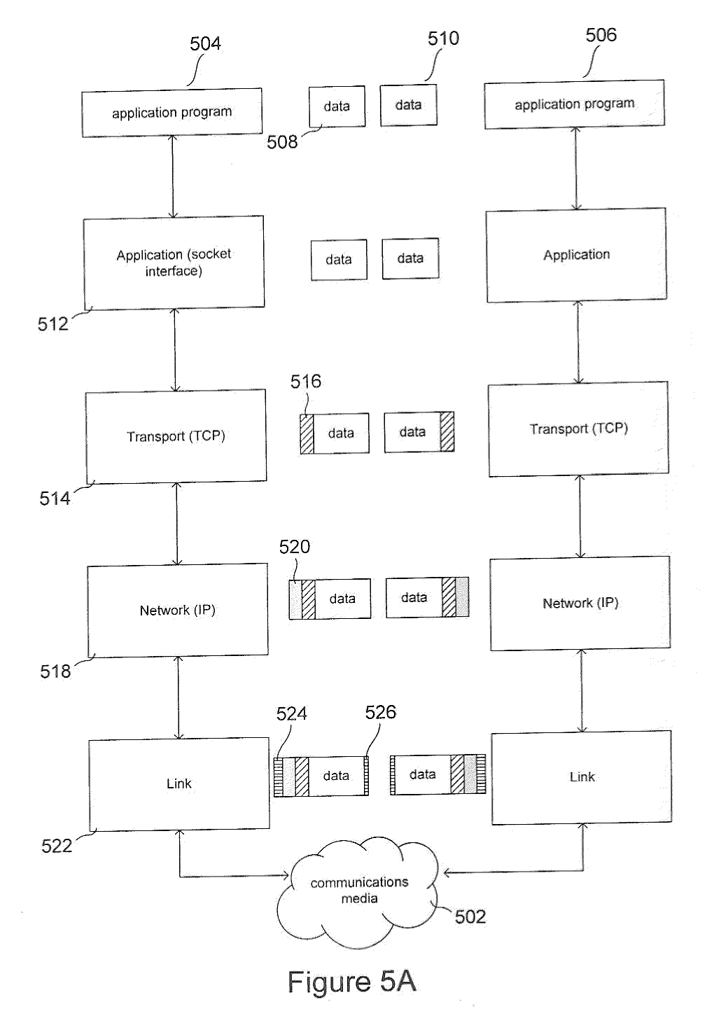

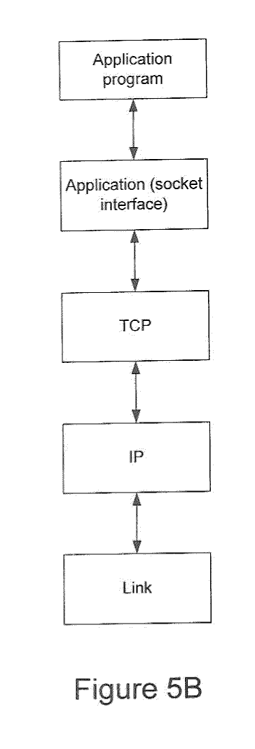

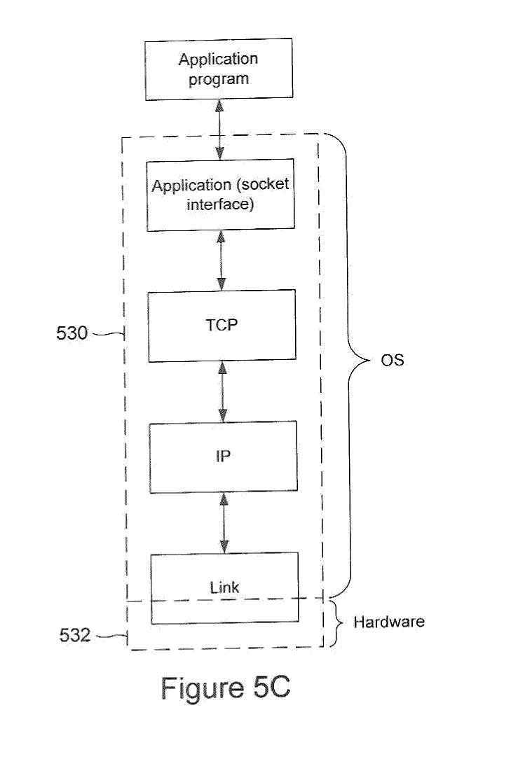

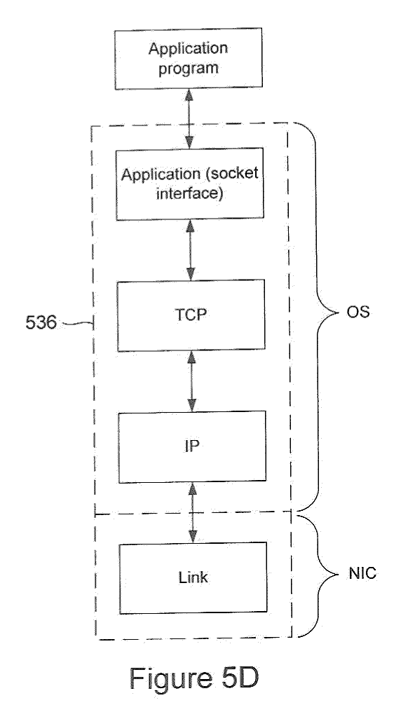

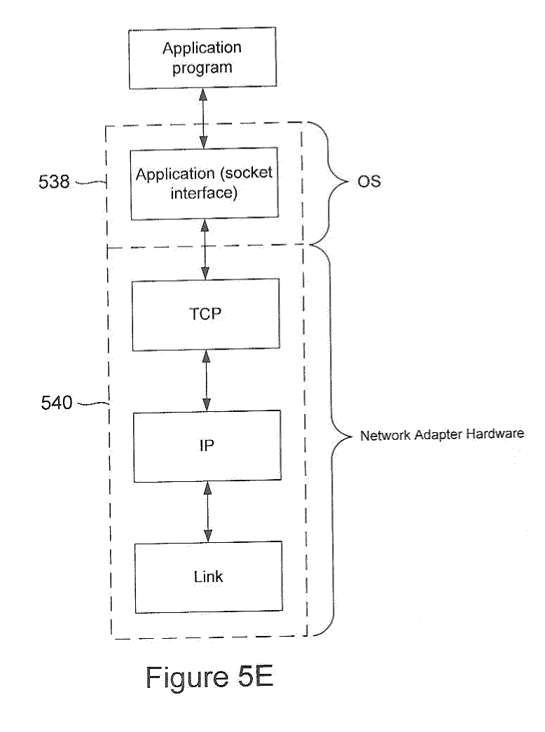

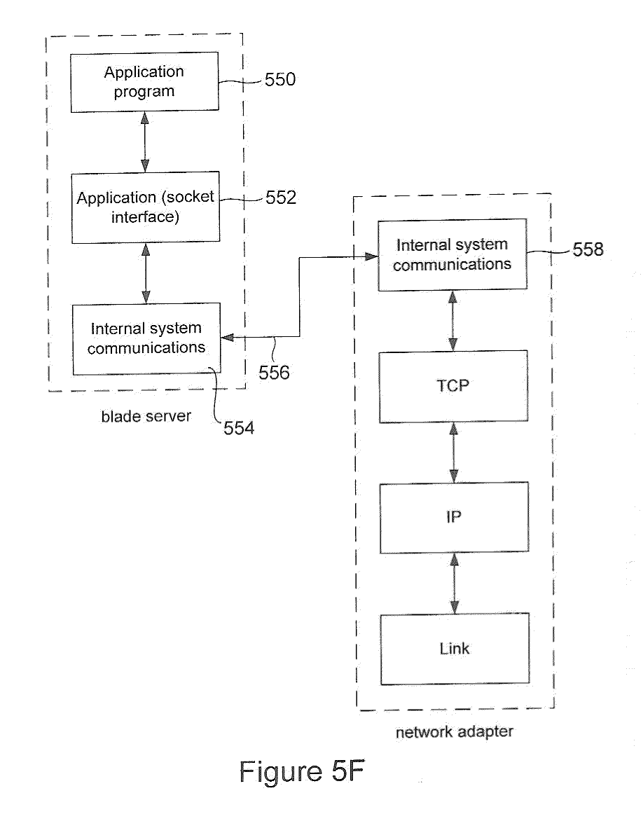

FIGS. 5A-F illustrate general network communications and the use of network subsystems within complex computational systems. FIG. 5A illustrates a generalized hierarchical layering of network-communications layers, similar to the layered routines 420 in FIG. 4. The left-hand portion of FIG. 5A represents layered communications software and a communications-hardware interface on a first computer and the right-hand portion of FIG. 5A represents identical layered communications software and a communications-hardware interface on a second computer. The two computers are interconnected by a communications medium 502, such as an Ethernet local area network or through a complex communications medium, such as the Internet. In general, the communications software and communications devices allow a first application program 504 on the first computer to exchange data with a second application program 506 on the second computer. The first application program on the first computer, for example, generates data 508 for transmission to the application program 506 on the second computer. Once the transmission is complete, the second application program 506 on the second computer receives a copy 510 of the data sent by the first application program 504 on the first computer. The first application program interfaces to a highest-level layer, often referred to as the application layer 512, within the layered communications software, also referred to as a “protocol stack.” As one example, the application program interfaces with the application layer to open a socket and transmit data through that socket to the application program 506 on the second computer. The application layer provides the functional interface for application programs, and provides a variety of services to application programs, including identifying communications partners, synchronizing communications between application programs, providing indications of available networking resources, providing certain types of data-transformation services that transform application-program data into a data form that can be transmitted through the network, and providing a session-level protocol for data exchange between communicating application programs. The application layer 512 interfaces with a transport layer 514.

The transport layer is concerned with providing reliable data exchange between computers, managing flow of data using various flow-control techniques, and detecting and handling various error conditions, including lost messages. One common transport-layer protocol is referred to as the transmission control protocol (“TCP”). The transport layer generally appends a transport-layer header 516 to the data to be transmitted. The transport layer 514 interfaces to a lower-level network layer 518. The network layer is responsible for packaging variable-length data into a sequence of messages, routing messages, and various other tasks. One common network-layer protocol is referred to as the “Internet protocol” (“IP”). The network layer generally appends a network-layer header 520 to the transport-layer encapsulated data. The network layer interfaces to a lowest layer 522, commonly referred to as the “link layer,” which is concerned with point-to-point communications with link layers of remote computers. The link layer is concerned with detecting and correcting certain types of hardware-level communications errors and correctly framing encapsulated data from the network layer into data packets or frames that can be transferred to a hardware controller for transmission through the communications medium. In general, the link layer includes both low-level operating-system routines, controller software and firmware, and the physical network controller that transmits data as signals through the communications medium. The link layer generally both appends a header 524 to, and adds additional data 526 at the end of, a frame to facilitate physical transmission, error detection, and routing. When the data packet or frame is received on the remote computer, the data packet or frame ascends the second computer's protocol stack from the link layer up through the application layer, removing the headers and additional information that encapsulate the application-level data that were added by corresponding layers on the first computer.

FIG. 5B shows the network protocol stack for a single server or computer. Originally, as shown in FIG. 5C, the application, transport, and network layers were implemented within the operating system of even large computer systems, as was a portion of the link layer, indicated by the dashed-line rectangle 530 in FIG. 5C. The lowest portion of the link layer 532 was implemented in a network controller card. However, as network communications have evolved, the bandwidth of communications media has increased substantially, requiring corresponding substantial increase in the computational throughputs of network protocol stack implementations. A greater proportion of the available computational bandwidth of the processor or processors of computer systems now need to be devoted to processing tasks represented by the network protocol stack, in systems in which the operating system includes the network protocol stack. Because of this, more advanced communications-hardware devices, including network interface cards (“NIC”) have been developed to offload network-communications processing from the processor or processors of computer systems to the NICs. FIG. 5D shows the use of an NIC that fully implements the lower, link layer of a network protocol stack. However, in Figure D, the operating system is still responsible for the first three layers 536 of the protocol stack.

The trend in offloading computational overhead to network devices has continued to offload greater proportions of the computational tasks of the protocol stack from the operating system. FIG. 5E shows partitioning of the network stack between the operating system and a network subsystem device in a modern large-scale computer system. The operating system is responsible only for the application layer 538, while the transport, network, and link layers are all implemented within a network subsystem 540. This results in offloading a large fraction of the computational overhead for network communications from the processor or processors of a computer system to the specialized network-subsystem. Finally, as shown in FIG. 5F, in complex multi-server systems, such as the multi-server system illustrated in FIG. 2, the network subsystem may be a separate component interconnected with server blades through an internal communications medium. FIG. 5F illustrates partitioning of communications overhead between a blade server and a separate network subsystem component of the multi-server system. The blade server is responsible for executing application programs 550 and for implementing the application layer 552 of the network protocol stack. The blade server also provides an internal communications interface 554 that allows the blade server to send application data to a network subsystem through an internal communications medium 556. The network subsystem implements an internal communications interface 558 and the transport, network, and link layers of the network protocol stack. Returning briefly to FIG. 2, for example, each blade server, such as blade server 216, implements the application layer of various network protocol stacks, and transmits application data through internal communications media to the network subsystem components 210-213 which implement the transport, network, and link layers of the network protocol stacks, and which include the physical network-controller devices that interface to physical communications media for transmitting data to computers external to the multi-server enclosure 202 and for receiving data from computers external to the multi-server enclosure 202.

Similarly, operating systems provide interfaces for application programs to store and retrieve data from mass-storage devices, using protocol stacks similar to the network protocol stack discussed with reference to FIGS. 5A-F. In similar fashion, much of the computational overhead associated with storing data and retrieving data from data-storage devices has been offloaded to storage subsystems or components (206-209 in FIG. 2). By including the network subsystem components and storage-adapter components in a multi-server enclosure 202 in FIG. 2, a much larger portion of the computational bandwidth of the multiple server blades included in the multi-server enclosure can be devoted to computational tasks other than network communications and data exchange with mass-storage devices and data-storage systems.

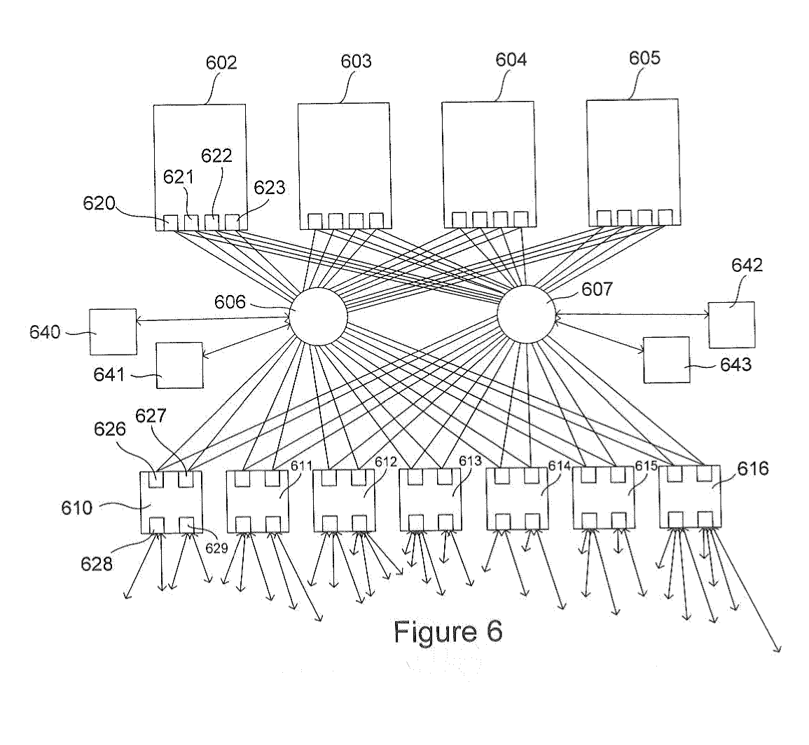

FIG. 6 illustrates communications interconnections within a multi-server enclosure, such as that shown in FIG. 2. In FIG. 6, four server blades 602-605 are fully and redundantly interconnected, in crossbar or Cartesian-cross-product-like fashion, through communications switches 606-607 to seven I/O modules (“IMs”) 610-616. Each server blade includes four communications ports, or adapters, such as ports 620-623 on server blade 602, that support communications, and each IM is shown to include two network adapters, such as network adapters 626-627 on IM 610. Each IM also includes multiple adapters, such as adapters 628 and 629 on IM 610, for communications between the IM and storage devices, external networks, and other communications media and/or external devices. Each IM generally serves as a storage subsystem, a network subsystem, or as both a storage subsystem and network subsystem, in various different implementations of a multi-server enclosure. The internal communications system also interconnects various additional components of the multi-server enclosure 640-643 with the server blades and with one another.

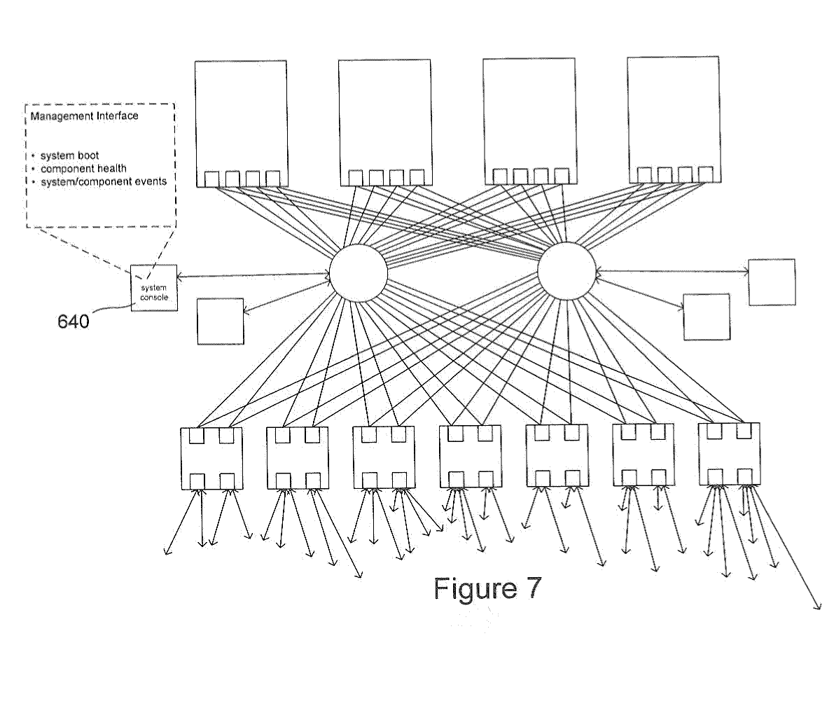

FIG. 7 illustrates the general management interface of a complex computational system, such as the multi-server enclosure shown in FIG. 2 and discussed with reference to FIG. 6. The multi-server enclosure includes a server-console component 640, generally implemented as a server dedicated to run a console program. The system console communicates with all of the components of the multi-server enclosure via the internal communications medium and/or and external communications medium., and provides, through a console terminal, virtual, web-based terminal, or other I/O device, a management interface 702 to one or more system administrators or other local or remote administrators or systems. The management interface allows a system administrator to boot the multi-server enclosure, monitor the health of the internal components of the multi-server enclosure, to be notified of, and, when necessary, handle, any of various events that occur during operation of the multi-server enclosure, and to configure and control the components of the multi-server enclosure.

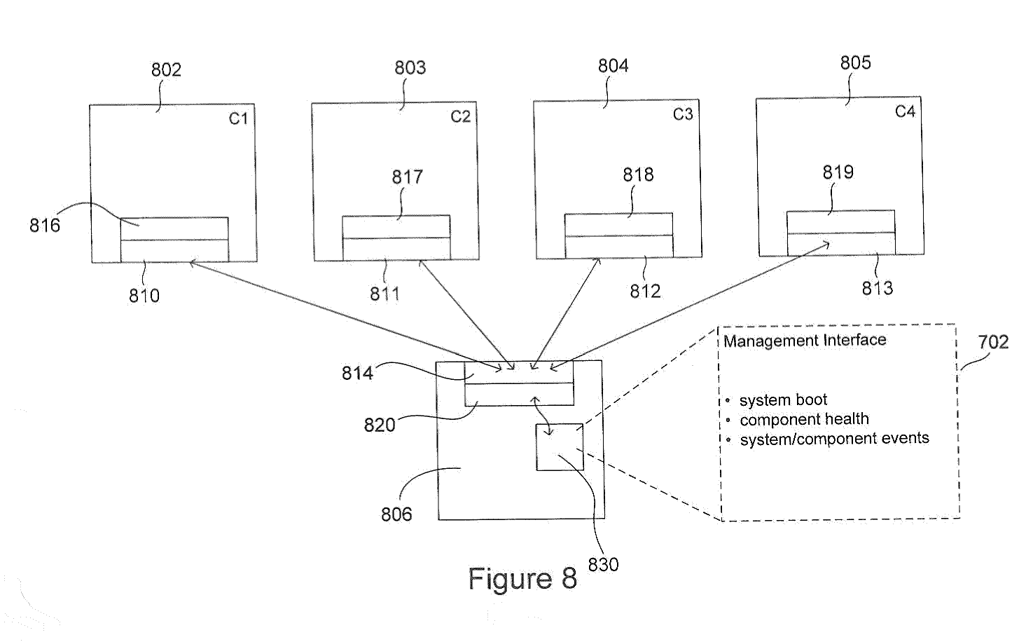

FIG. 8 illustrates the general approach for internal management of the multi-server enclosure discussed above with reference to FIGS. 2, 6, and 7. In FIG. 8, four components 802-805, representative of many tens or hundreds of components in a multi-processor enclosure, are shown interconnected with a system-console component 806. Each component, including the system-console component, includes one or more communications ports and control programs, shown as communications components 810-814 in FIG. 8, as well as a management component, shown as management components 816-820 in FIG. 8, that interfaces to internal software, firmware, and hardware subcomponents of each component for management purposes. The console component 806 includes a console program 830 which interfaces to the management component 820 within the console component 806 in order to collect information from the various components of the multi-server enclosure, communicate commands and instructions to the various components of the multi-server enclosure, and to carry out data exchange and other tasks that allow the console program 830 to provide the management interface 702 to system administrators and to carry out various functions and tasks provided to system administrators through the management interface.

In various multi-server enclosures, and other complex computational systems, the IMs can be special-purpose components specifically designed to serve within complex computational systems as network subsystems, data-storage subsystems, and other such subcomponents. However, special-purpose hardware is both expensive and time consuming to develop, test, debug, and manufacture. In a variety of complex computational systems, including multi-processor enclosures and large distributed computing systems that represent embodiments of the present invention, existing, stand-alone server systems are instead used as IMs by running dedicated IM control programs on the existing, stand-alone systems. In other words, the network subsystems and storage subsystems in a multi-server enclosure that represents an embodiment of the present invention, such as the multi-server enclosure shown in FIG. 2, are general-purpose servers that are adapted for use as network subsystems and storage subsystems by running network subsystem and storage subsystem control programs. However, use of these pre-existing, stand-alone servers as IMs presents certain management challenges. For example, the stand-alone servers may run a different operating system than that run on the server blades, and may lack the management components that are built into special-purpose hardware designed specifically for use in the multi-server enclosure. Therefore, the console program may not be able to detect, configure, boot, query, and issue commands to the stand-alone server IMs.

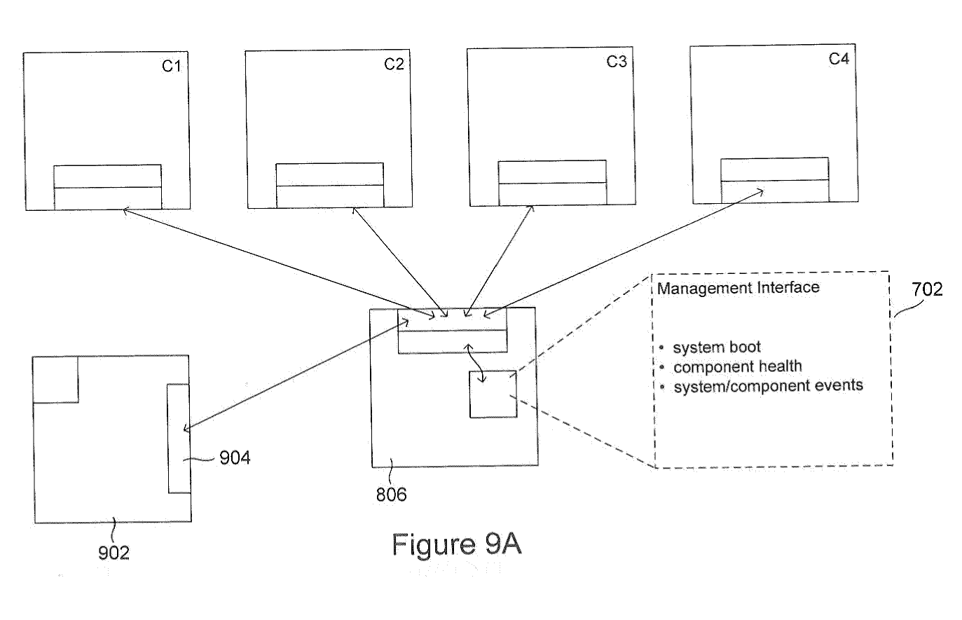

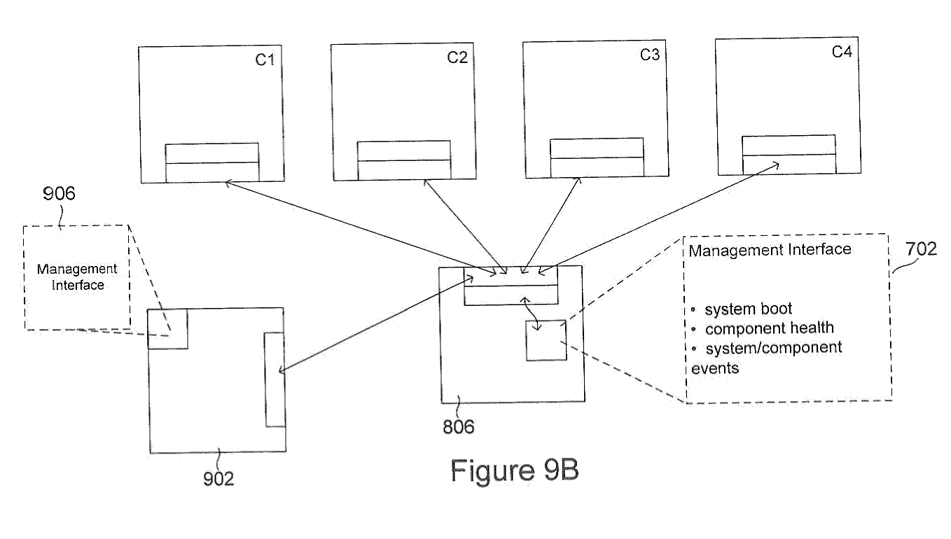

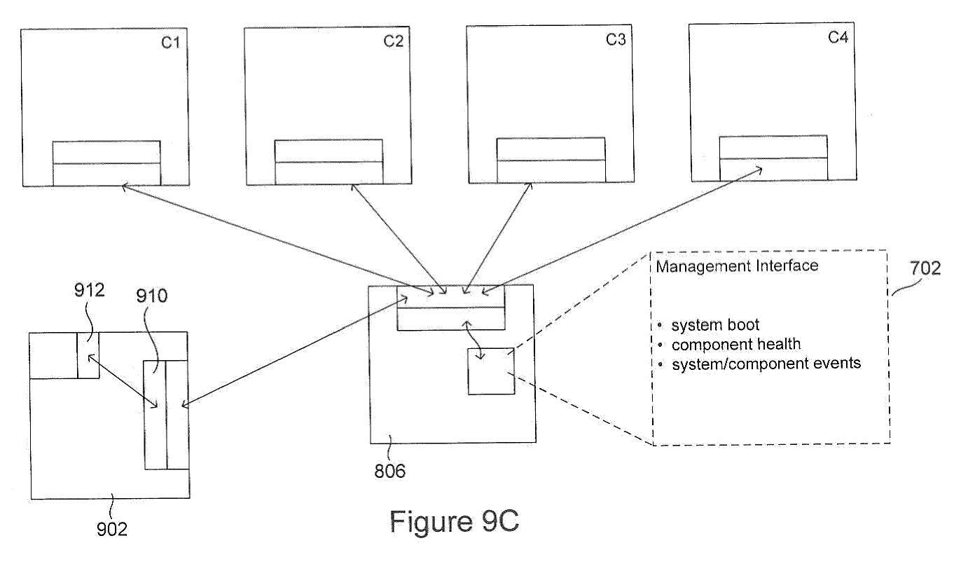

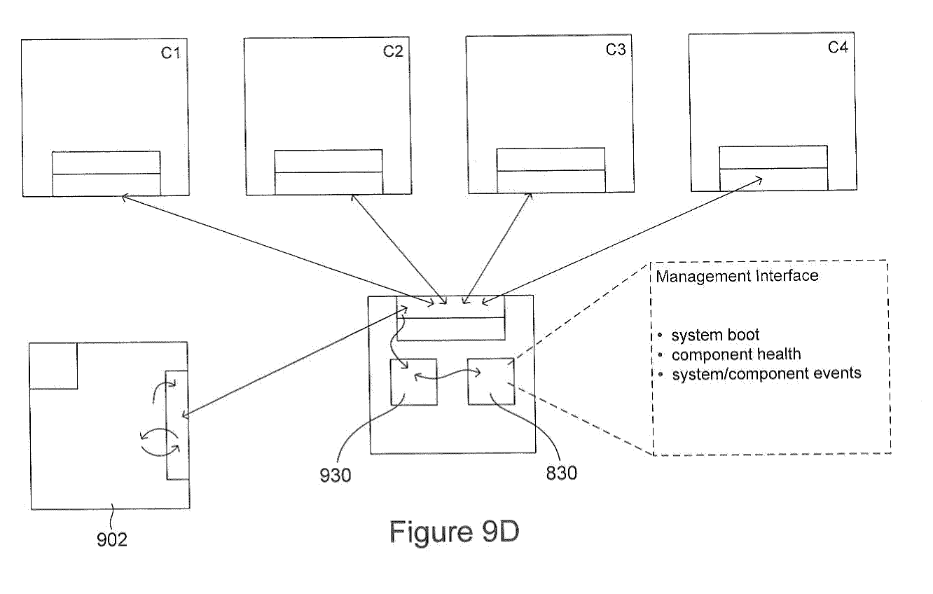

FIGS. 9A-D illustrate various approaches to managing stand-alone systems used as components and subsystems within a larger computational system, including an approach used in embodiments of the present invention. In FIG. 9A, a stand-alone server 902 has been introduced into the multi-server enclosure shown in FIG. 8. The stand-alone server 902 includes a network adapter and interface 904 that interconnects the stand-alone server 902 with the console component 806. The console component, as discussed briefly above, needs to receive information from the stand-alone server 902 and needs to send commands and instructions to the stand-alone server 902 in order to carry out the variety of system-administration tasks and functionalities to allow the console to support the management interface 702.

FIG. 9B illustrates one approach to management of a complex computational system that includes stand-alone systems as subsystems or components. As shown in FIG. 9B, the stand-alone server 902 used as an IM within the complex computational system generally already includes a management interface provided by a management control program. One approach to overall system management would be to use the management interface 906 provided by the stand-alone server 902 in addition to the management interface 702 provided by the console component 806. Advantages of this approach include almost no need for additional development with respect either to the complex computational system, as a whole, or the stand-alone server used as an IM. However, there are disadvantages with this approach. First, system administrators expect to be provided a single management interface for an entire system. Often, the management interface provided by a stand-alone server or other system used as a subsystem, such as stand-alone server 902 in FIG. 9B, is substantially different from that provided by the complex computational system, and system administrators would be required to learn to use a number of different management interfaces in order to manage the complex system that includes stand-alone-system components. Moreover, both the complex computational system management interface 702 as well as the stand-alone system management interface 906 both generally allow certain characteristics and parameters of a stand-alone-system component to be altered. Thus, for example, the system management interface 702 may be used to configure network addresses within components of the system, including the stand-alone server 902, and the management interface 906 provided by the stand-alone component may allow a system administrator to alter, or override, the network addresses configured through the system management interface 702, without informing the console component 806 of the network-address changes. This can lead to serious problems and even to system failure. For these and various additional reasons, using the stand-alone server management interface 906 in addition to the multi-server-enclosure management interface 702 is not a desirable approach to overall system management.

FIG. 9C shows a second approach to system management in a system that employs stand-alone systems as subsystems or components. As shown in FIG. 9C, the stand-alone system 902 is enhanced to include a management interface 910 similar to, or identical to, the management interfaces 816-820 included in the other components of the multi-server enclosure. By developing an internal management component 910 within the stand-alone system, and by developing additional interfaces, such as interface 912 in the internal system to translate management-related events, information, and command instructions to interface with the management component 910, the stand-alone system can be fully incorporated within the overall system management scheme for control through the management interface 702 provided by the console component 806. While this approach would appear to be relatively seamless and desirable, the approach of fully incorporating the stand-alone system within the multi-server enclosure, shown in FIG. 9C, can be both expensive and time consuming, since interface 912 would need to be designed and implemented, and management component 910 engineered to adapt the management component to the stand-alone-system component. Moreover, each different type of stand-alone system would require design and production of specialized management components and additional interfaces to fully incorporate each different type of stand-alone system into a complex computational system. For this reason, the second approach, illustrated in FIG. 9C, may be less than optimal or even practical in many cases.

FIG. 9D illustrates an approach for overall system management of systems that include stand-alone systems as subsystems or components that represents one embodiment of the present invention. In the approach shown in FIG. 9D, various enhancements 930 are made to the system console in order to translate information received from the stand-alone-server component 902 into a form expected by the system console program 830 and to translate commands and instructions forwarded by the console program 830 to the stand-alone-server component into commands and instructions that can be executed by the stand-alone server 902. In other words, rather than significantly enhancing or re-engineering a stand-alone-system component, the system console of the complex computational system, such as a multi-server enclosure, is enhanced in order to adapt the console program 830 to the stand-alone-system component. In general, the stand-alone-system component will include certain low-level operations and features that can be exploited in order to obtain information from the stand-alone-system component and to transmit instructions to carry out operations on the stand-alone-system component on behalf of the console program. As an example, stand-alone systems generally include event detection and reporting facilities, health-monitoring facilities for monitoring the health of internal components, and interfaces that allow a stand-alone system to be booted by external devices. Thus, the approach that represents one embodiment of the present invention exploits the pre-existing, low-level facilities of the stand-alone-system component to enhance the console program of the complex system in order to provide overall system management.

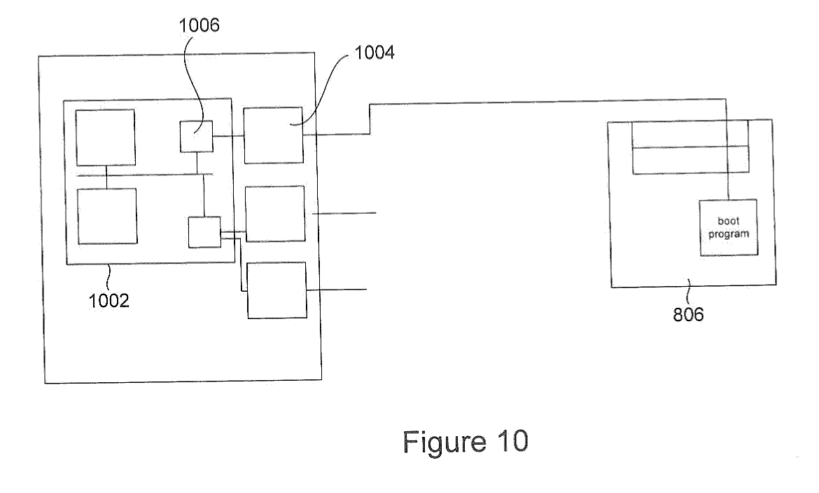

FIG. 10 illustrates one feature of certain stand-alone systems, such as servers, that can be exploited by the system console component of a complex computational system for system-management purposes. In certain stand-alone servers 1002, a dedicated communications controller 1004 is provided to allow external machines to interface with the server. In particular, the HP integrated lights-out subsystem (“iLO”) provides internal hardware 1004 and a controller 1006 that allow an external device to issue a boot command to the server. This can be exploited by a console-component 806 boot program to issue a boot command to the stand-alone-server component of a complex system that includes the stand-alone-server component. Thus, a stand-alone server included as an embedded subsystem or component within a multi-server enclosure can be interconnected with the console component so that the console component can be enhanced to issue boot requests to the stand-alone-system component, using already engineered facilities included in the stand-alone-system component. A boot program running as a module of the console program of a complex computational system needs only to detect the presence of the stand-alone-system component, determine that the stand-alone-system component can be booted via the iLO interface, and then issue the proper iLO-interface boot command through the iLO interface.

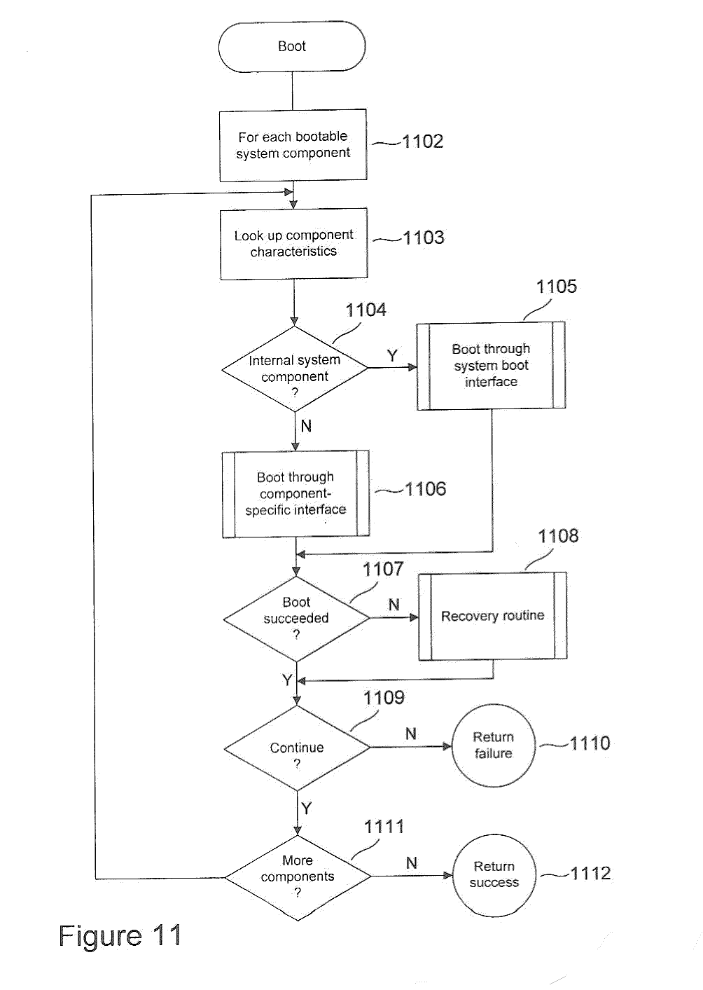

FIG. 11 provides a control-flow diagram for the boot routine within a console program of a console component of a complex computational system that includes stand-alone systems as subsystems or components. In the for-loop of steps 1102-1112, the boot routine considers each component within the complex computational system that needs to be booted during booting of the complex computational system. In step 1103, the boot routine looks up the currently considered components' characteristics in a table or database. When the currently considered component is a special-purpose internal system component of the complex computational system, as determined in step 1104, then the component is booted through the normal system-boot interface, in step 1105, built into special-purpose system components. However, when the component is a stand-alone-system component included as a subsystem or component within the complex computational system, as also determined in step 1104, the stand-alone-system component is booted through a stand-alone-system-component-specific interface, such as the iLO boot mechanism discussed above with reference to FIG. 10, in step 1106. When the boot fails, a recovery routine is invoked, in step 1108. When the boot succeeds, or the recovery routine succeeds, then, when more components remain to be booted, control returns to step 1103. Otherwise, success is returned in step 1112. When a boot failure cannot be recovered, as determined in step 1109, then a failure indication is returned in step 1110.

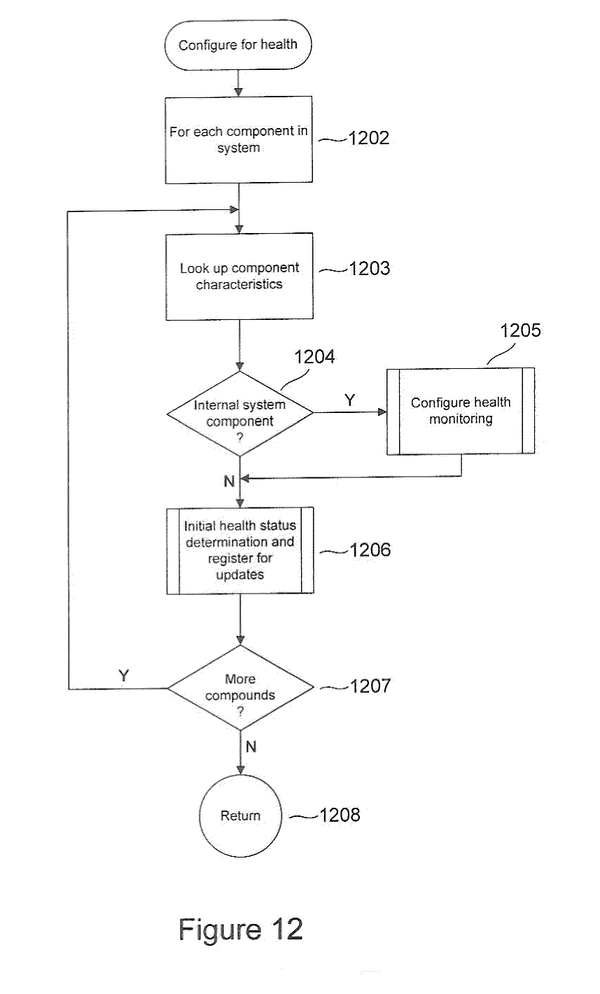

FIG. 12 is a control-flow diagram for a configure-for-health-monitoring routine within a console program of a complex computational system that includes stand-alone systems as subsystems or components. The routine consists of a for-loop, comprising steps 1202-1208, that considers each component of the complex computational system that is monitored by the console program. For each component, the component characteristics are looked up in a table or database. When the currently considered component is a special-purpose internal system component of the complex computational system, then health monitoring is configured by normal procedures, in step 1205. Otherwise, in step 1206, one or more stand-alone-component-specific commands are invoked by the console program in order to make an initial health status determination, and the console program then registers for reception of subsequent health-status updates generated by the stand-alone-system component, using an event-notification facility on the stand-alone-system component and possibly relying on an event capture, packaging, and transmission utility developed for the stand-alone-system component to facilitate health monitoring by the console program of the console component of the complex system. Again, the console program of the complex computational system is modified to employ the health-status-determining and health-monitoring facilities of the stand-alone-system component, rather than the stand-alone-system component being re-engineered or enhanced in order to conform to the complex computational system management interface.

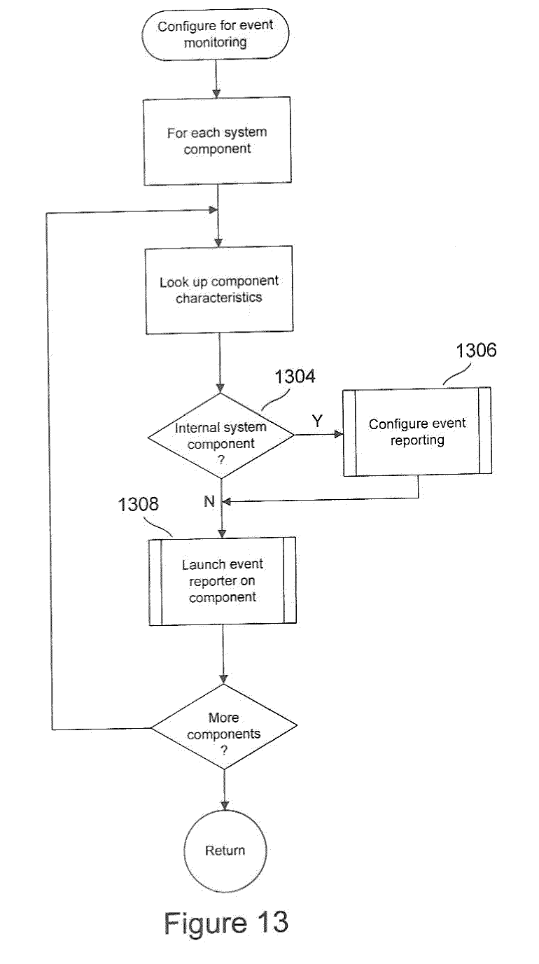

FIG. 13 shows a control-flow diagram for configuring, for event monitoring, components of a complex computational system that includes stand-alone-system components as subsystems for components. The flow-control diagram in FIG. 13 is similar to that in FIG. 12, with the console program determining, in step 1304, whether a currently considered component is a special-purpose internal system component of the complex computational system, in which case normal event reporting is configured in step 1306, or whether the component is a stand-alone component, such as the stand-alone server 902 in FIG. 9B, in which case the console program launches an event reporter, in step 1308, on the stand-alone-system component. The event reporter can be a simple monitoring routine that registers for receiving internal events within the stand-alone-system component and that periodically bundles those events and reports them to the console program through the a communications medium.

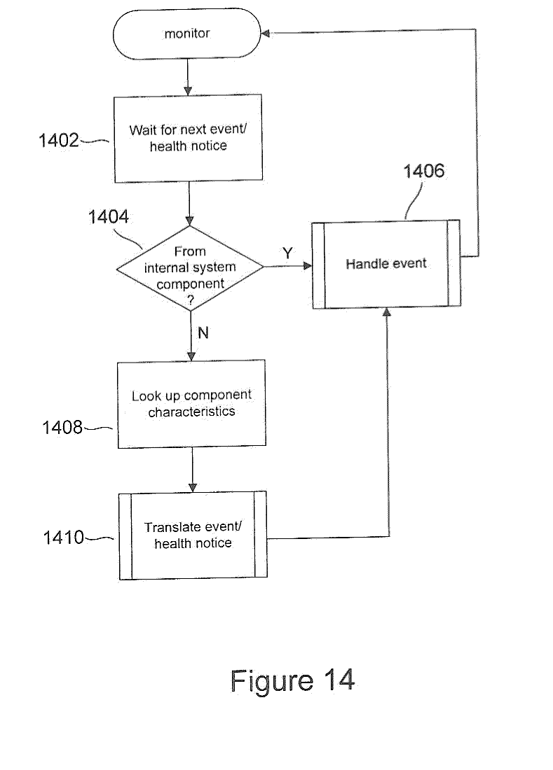

FIG. 14 is a control-flow diagram for a monitoring routine within a console program of a complex computational system that includes stand-alone systems as subsystems or components. A monitoring routine executes continuously, waiting in step 1402 for a next event to occur or a next health notice to be received. When the event or health notice is received from a special-purpose internal system component of the complex computational system, as determined in step 1404, then the event or health notice is handled in normal fashion by the console program, in step 1406. Otherwise, in step 1408, the console program looks up characteristics of the currently considered component in a table or database and uses the component characteristics to translate the received event or health notice, in step 1410, into a form that can be processed by the normal event or health-notice handling routine, to which the translated event or health notice is forwarded for processing in step 1406.

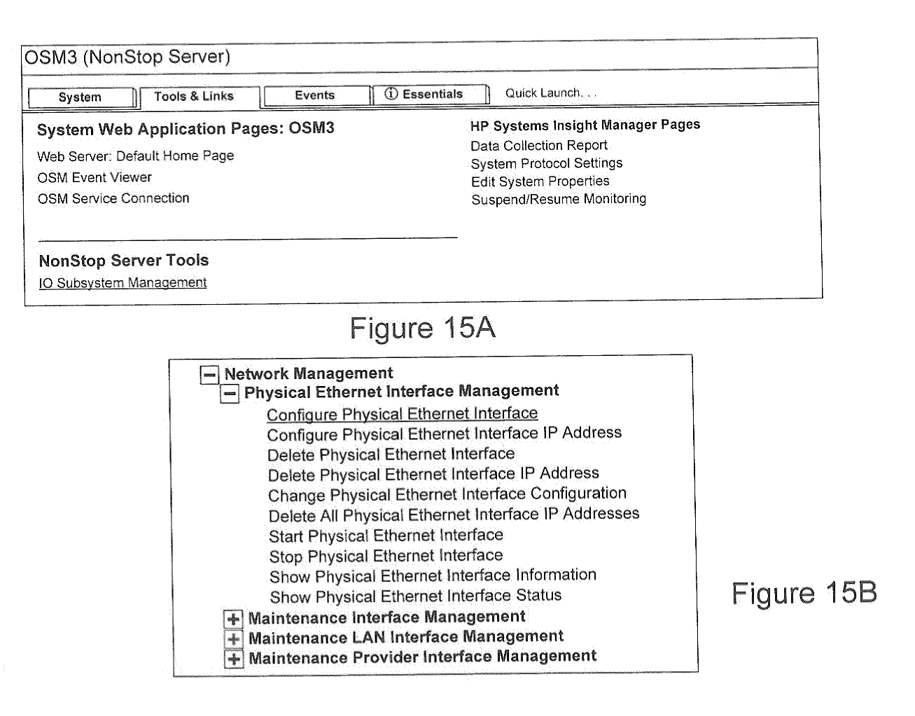

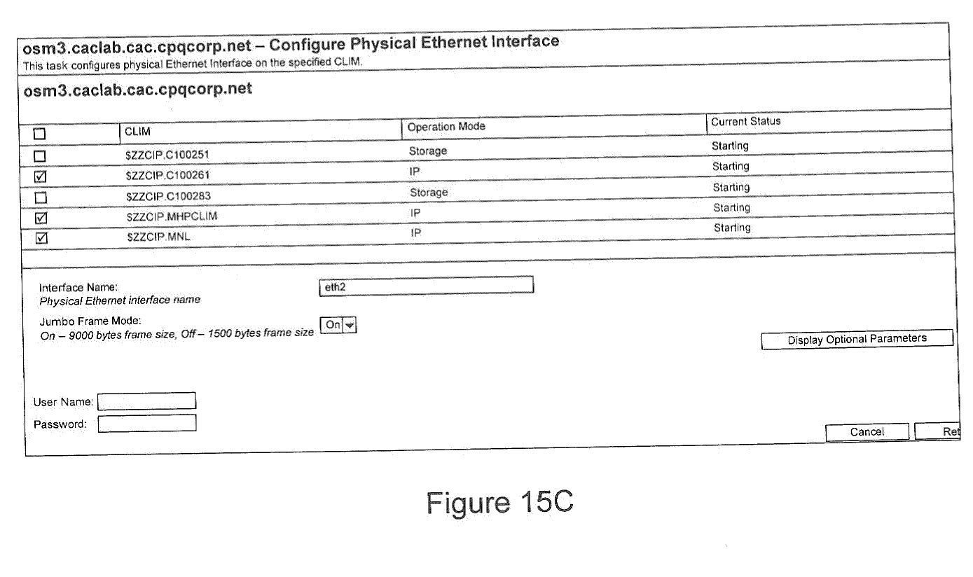

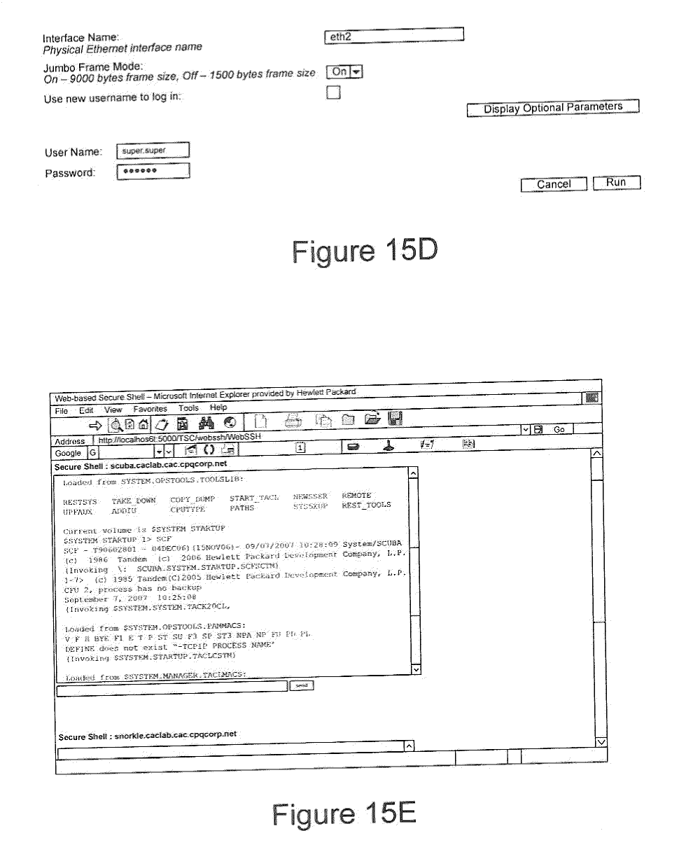

FIGS. 15A-E illustrate a complex-system management interface that provides management of a complex computational system that includes stand-alone systems as subsystems or components according to one embodiment of the present invention. FIGS. 15A-E show a series of display screens of a complex-system management interface that allows a stand-alone-system component to be configured, according to one embodiment of the present invention. From the top-level screen, shown in FIG. 15A, a system administrator navigates to a network-management screen, shown in FIG. 15B. Selecting, from that screen, an option to configure a physical Ethernet interface, the system administrator is presented with the input screens shown in FIG. 15C-D, which allows the system administrator to select configuration parameters for particular Ethernet devices of a particular IM. The actual secure-shell script communicated from the system console to the IM is displayed in the screen shown in FIG. 15E. In this case, a native configuration script for the IM is constructed and transmitted by the console program of the multi-server enclosure, according to the present invention, rather than requiring the system administrator to be familiar with the internal interfaces of the stand-alone-server used to implement the IM.

The complex-system management interface described above, with reference to FIGS. 15A-E, can be implemented in many different ways. In one implementation that represents an embodiment of the present invention, the management interface is data driven. A data-driven implementation provides for a simple, intuitive, user-friendly management interface that can be easily updated and enhanced in order to accommodate a changing set of embedded systems within the complex system. The complex-system management interface also generally provides an application-programming interface to allow for automated system management or management through applications developed to the application-programming interface.

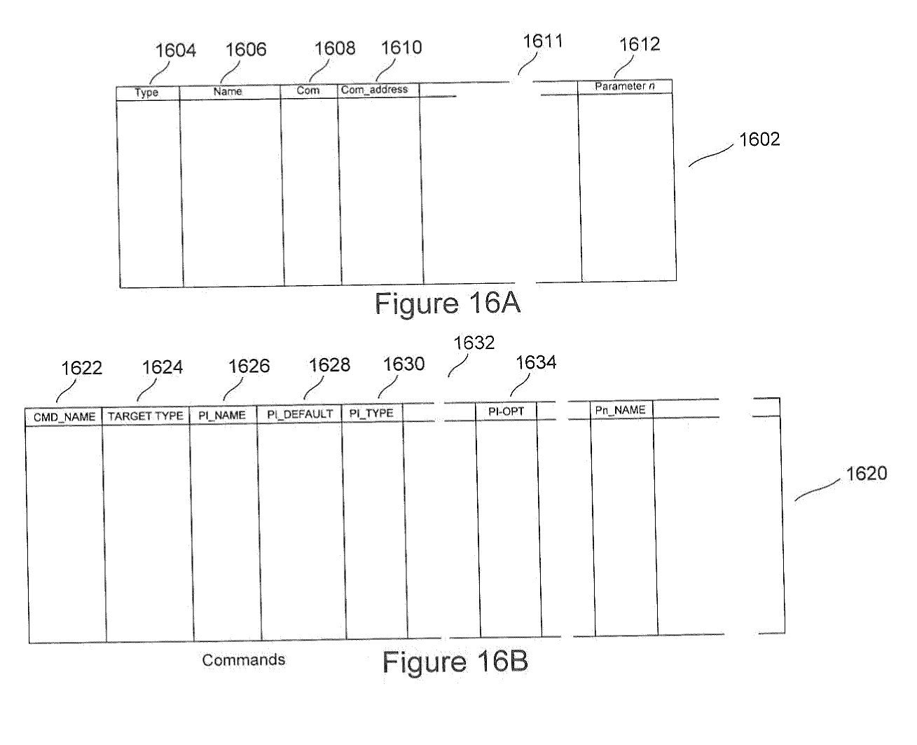

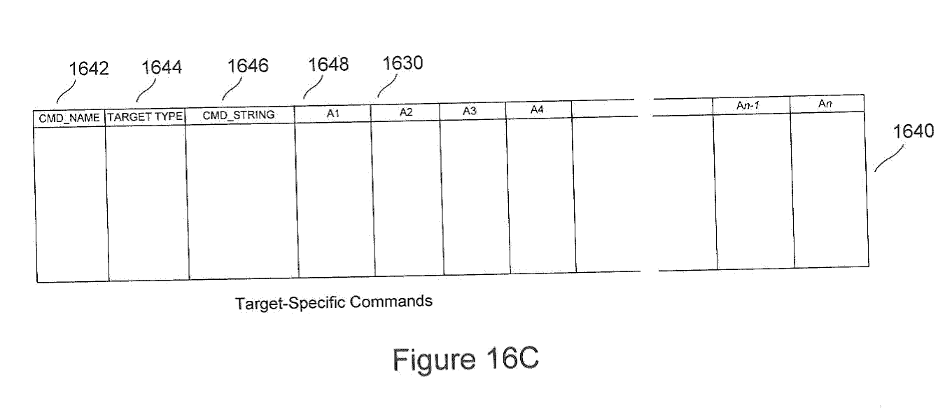

There are many ways to implement a data-driven complex-system management interface. In one approach, descriptions of the target embedded systems, generic, high-level system-management commands, and target-specific management commands are stored in a database that is accessed in order to construct complex-system management-interface graphical displays as well as to translate generic system-management commands into target-specific system-management commands. FIGS. 16A-C illustrate three exemplary tables of a relational database used to implement a data-driven complex-system management interface according to one embodiment of the present invention. FIG. 16A shows a table “Targets.” The table “Targets” 1602 includes relational-database-table rows that each describes a particular target embedded system. Note that, in FIGS. 16A-C, and in subsequent figures showing relational-database tables, the rows are not explicitly shown. Instead, indications of the columns, equivalent to fields within records, are shown in Figure 16A and remaining figures. A target embedded system is described by a system type 1604, a system name 1606, an indication of the type of communications path by which the system can be accessed for system-management purposes 1608 and a communications address for the system 1610, along with any of many other additional parameters 1611-1612 of various types that characterize the embedded system. For example, parameters may provide indications of type of operating system or control program executing on the embedded system, a characterization of various types of facilities offered by the embedded system through the communications medium, and other such parameters that allow the complex-system management interface to communicate with the target embedded system. The data types for the fields represented by columns may vary with different implementations. Data types include strings, integers, real numbers, and unstructured data. Data is found in, retrieved from, inserted into, and updated within tables via a query language, such as SQL. For example, all high-level commands represented by entries in the table “Commands” that can be directed to a specific type of target embedded system can be retrieved using a single SQL query.

FIG. 16B illustrates a relational table “Commands” used in a data-driven complex-system management interface that represents one embodiment of the present invention. Each row of the table “Commands” 1620 describes a generic command for a type of complex-system management command that can be directed, by a system administrator or other user, to an embedded system within the complex system. A high-level command template can be characterized by: (1) a command name 1622; (2) a target type 1624 indicating the type of target systems that the command can be directed to; and (3) and specification of parameters for the command, where each parameter is specified by a name 1626, a default value 1628, a parameter data type 1630, and other such parameters 1632, finally including a parameter 1634 that indicates whether or not the parameter is optional. Additional parameters of a high-level command may indicate whether or not the command can be concurrently executed against multiple target embedded systems, or whether the command must be serially executed against a group of target systems. Yet additional parameters may indicate various constraints on command execution, or control the format for returned information generated by command execution.

FIG. 16C illustrates a target-specifics commands table using a data-driven complex-system management interface that represents one embodiment of the present system. The table “Target-Specific Commands” 1640 includes rows that contain templates for embedded-system-native management commands to which high-level commands stored in the table “Commands,” discussed above with reference to FIG. 16B, are translated. The table “Target-Specific Commands” includes columns that specify: (1) the command name 1642 of an associated high-level command represented by an entry in the table “Commands;” (2) an indication of the target type of embedded system for which the target-specific command is valid 1644; and (3) a command string 1646 that represents the literal command with arguments that are substituted with parameter values in order to create a final embedded-system-native management command that can be directed to a target-specific command for execution by a target-embedded system. Each of the arguments, such as argument A1 1648, is associated with a column that specifies the corresponding parameter of the high-level command which is translated to the target-specific command by the data-driven complex-system management interface in order to create a corresponding embedded-system-native management command.

The relational tables discussed above with reference to FIGS. 16A-C provide an example of a database schema used to drive a data-driven complex-system management interface. In alternative embodiments, a greater number, a fewer number, or different tables containing different columns may be employed to describe the management interface, target systems, and management-system interface commands.

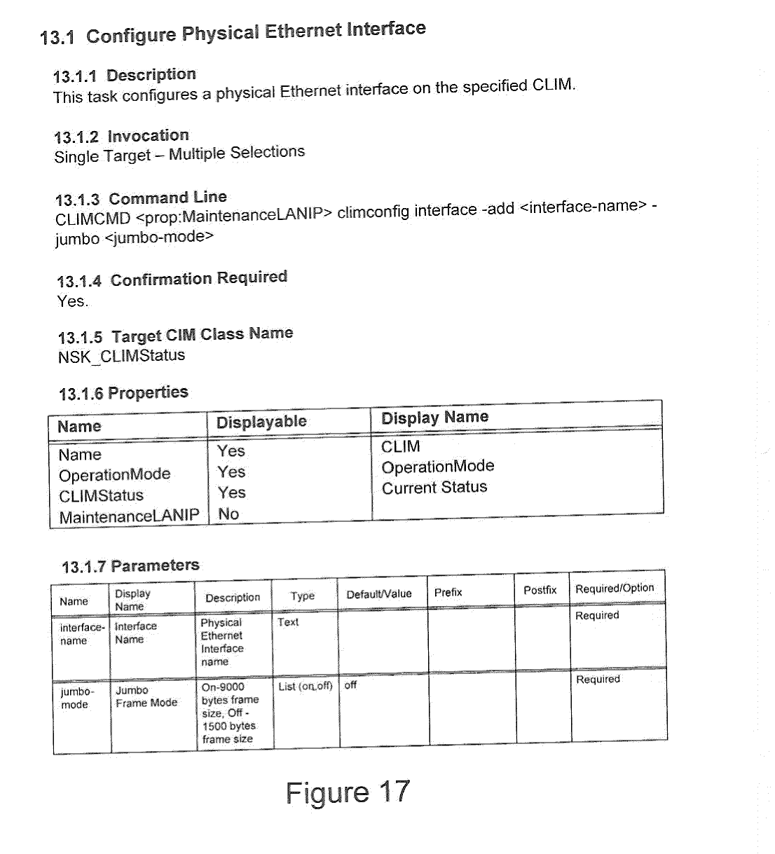

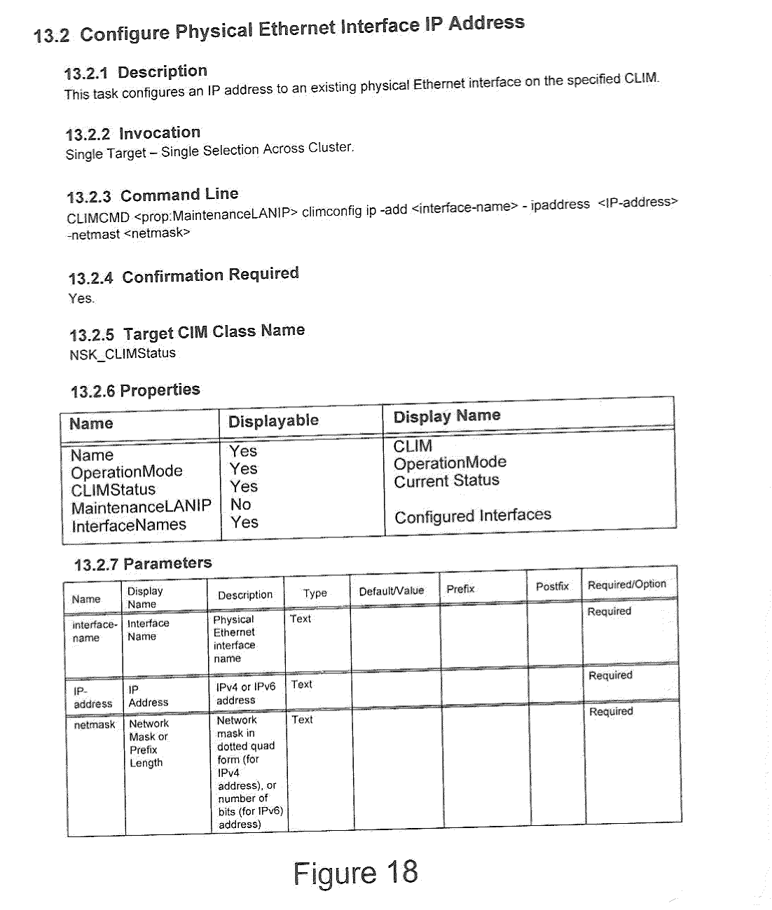

FIGS. 17-18 illustrate, for a specific complex system, the type of information and parameters associated with two high-level system-management commands according to one embodiment of the present invention. FIG. 17 shows details concerning a “configure physical Ethernet interface” command, and FIG. 18 provides details of a “configure physical Ethernet interface IP address” command.

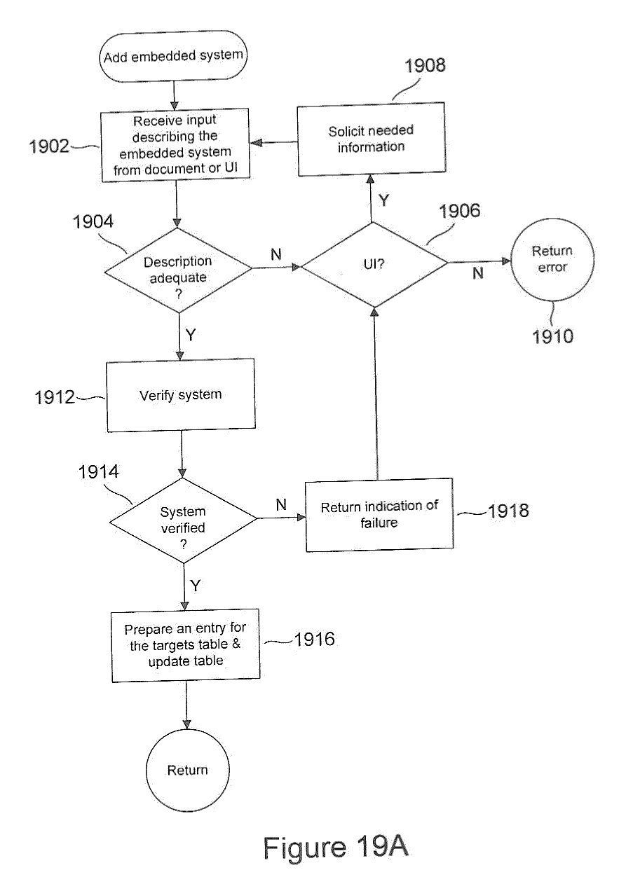

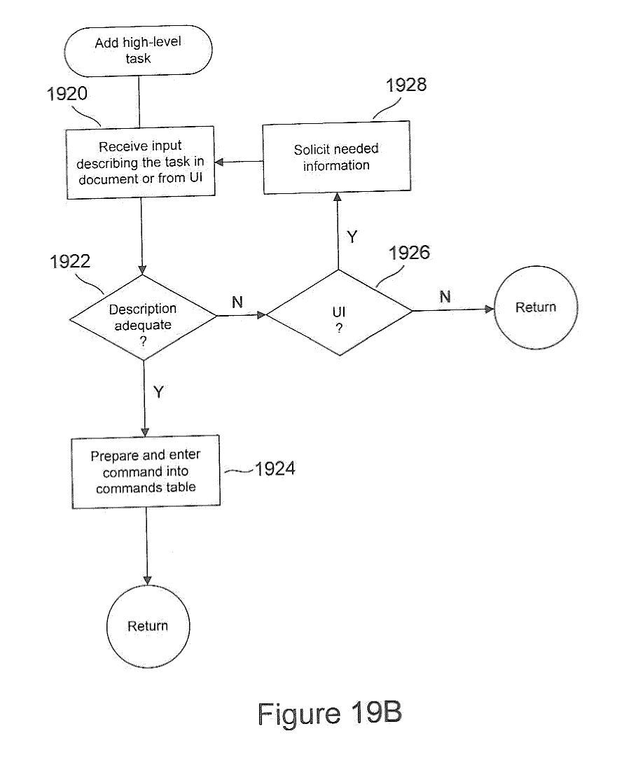

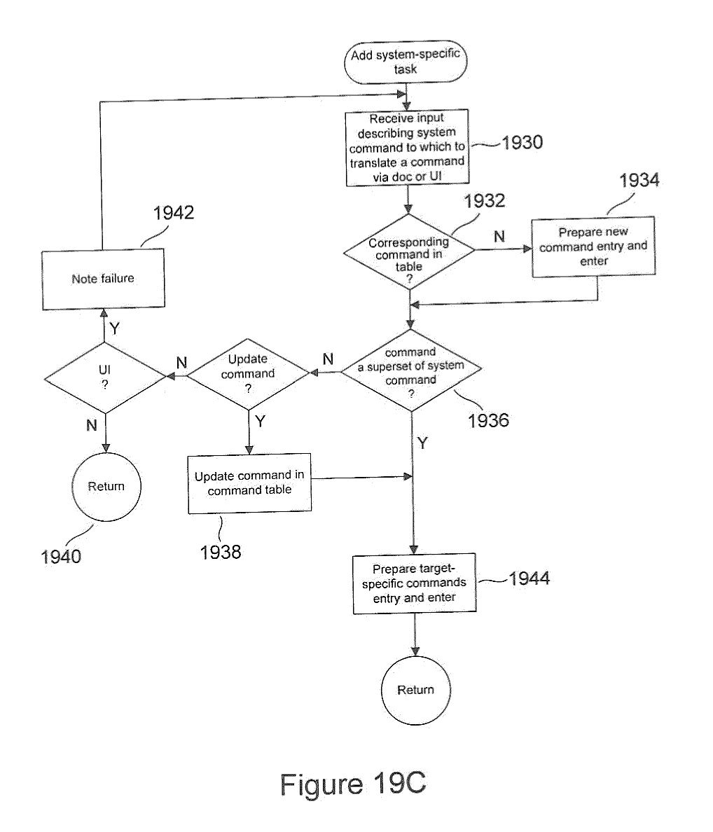

FIGS. 19A-C provide control-flow diagrams for portions of a complex-system management interface configuration interface that allows system administrators and other users to update, change, and otherwise configure a data-driven, complex-system management interface that represents one embodiment of the present invention.

FIG. 19A provides a control-flow diagram for a routine “add embedded system” that allows a system user or other user to add an embedded system to the set of systems represented by rows in the table “Target,” described above with reference to FIG. 16A, within a complex-system management interface that represents one embodiment of the present invention. In step 1902, input describing the target embedded system to be added to the table “Target” is received in the form of a text document, XML file, or input through a management-interface-configuration user interface. The information describing the embedded system is extracted from the received input. The routine “add embedded system” then compares extracted information to the information needed for preparing an entry for insertion into the table “Target.” When the received information is not adequate to construct and enter a new row into the table “Target,” as determined in step 1904, then, when the user-supplied information is received through a user interface, as determined in step 1906, additional needed information is solicited from the user in step 1908, with control flowing back to step 1902 to process the additional information. Otherwise, an error is returned in step 1910. When the received information is adequate, then, in step 1912, the routine “add embedded system” undertake steps to verify that the embedded system described by the received information can be accessed by the complex-system management interface. For example, the complex-system management interface can direct a message through a communications system to the embedded system to determine whether or not the embedded system responds correctly. Additionally, using the information provided about the embedded system, the routine “add embedded system” can attempt to access, through the communications medium, facilities described as being provided by the embedded system. In alternate embodiments of the present invention, the embedded-system description is added without verification. When verification succeeds, as determined in step 1914, an entry for the table “Target Systems” is prepared and entered into the table in step 1916. Otherwise, failure information is returned to a user through any of various mechanisms, in step 1918. Similar routines may be provided for deleting embedded systems from the table “Target Systems,” as well as editing entries already present in the table “Target Systems.” In yet additional embodiments of the present invention, the complex-system management interface may undertake automated detection as a configuration of embedded systems so that at least a portion of the table “Target Systems” may be automatically constructed.

FIG. 19B provides a control-flow diagram for the routine “add high-level task.” This routine provides a system administrator or other user with the ability to supplement the high-level management commands that can be directed through the complex-system management interface to embedded systems. In step 1920, input describing the high-level task is received via a document, XML file, or through a user interface. If the description is adequate to prepare a row in the table “Commands,” as determined in step 1922, then a row is prepared and entered into the table “Commands” in step 1924. Otherwise, when the information about a new high-level command is received through a user interface, as determined in step 1926, then additional information is sought from a user through the user interface in step 1928. As with the previously described routine “add embedded system,” additional routines can be provided to delete high-level commands from the table “Commands” as well as to update already existing entries in the table “Commands.”

FIG. 19C provides a control-flow diagram for a routine “add system-specific task.” This routine allows a system administrator or user to add an additional target-specific command template to the table “Target-Specific Commands.” In step 1930, input describing a target-specific command is received via a text file, an XML file, or a user interface. As for the two previous routines, although not shown in FIG. 19C, when the provided information is inadequate to create an entry within the table “Target-Specific Commands,” either an error is returned or additional information is solicited through the user interface. Next, in step 1932, the routine “add system-specific task” determines whether there is a high-level command in the table “Commands” corresponding to the target-specific command. When there is no corresponding high-level command in the table “Commands,” a new high-level command is prepared, in step 1934, and entered into that table. In alternative embodiments of the present invention, an error can instead be returned, requiring a user or system administrator to add the high-level command through an invocation of the previously described routine “add high-level task.” Then, in step 1936, the routine “add system-specific task” determines whether or not the received system-specific command is a subset of the associated high-level command. In other words, the arguments used in the system-specific command need to have matching parameters in the high-level command. When the task-specific command information is not a subset of the corresponding system command, and in the case that the command table can be updated by the routine “add system-specific task,” the high-level command is updated in step 1938 to add corresponding parameters to the high-level command to which the target-specific command is related. Otherwise, an error is returned, in step 1940, or failure is noted and additional information sought, in step 1942. Finally, when the target-specific command is adequately described by user input, and when the specified target-specific command corresponds to a corresponding high-level command, an entry is prepared and entered for the received system-specific task into the table “Target-Specific Commands” in step 1944. As with the previously described routines, additional routines can be provided to allow a user or system administrator to update existing target-specific commands as well as to delete such commands from the table “Target-Specific Commands.” Thus, using simple text files, XML files, or graphical user interfaces, a system administer or other user can configure the complex-system management interface to provide user-defined management tasks that are issued to embedded systems within the complex system.

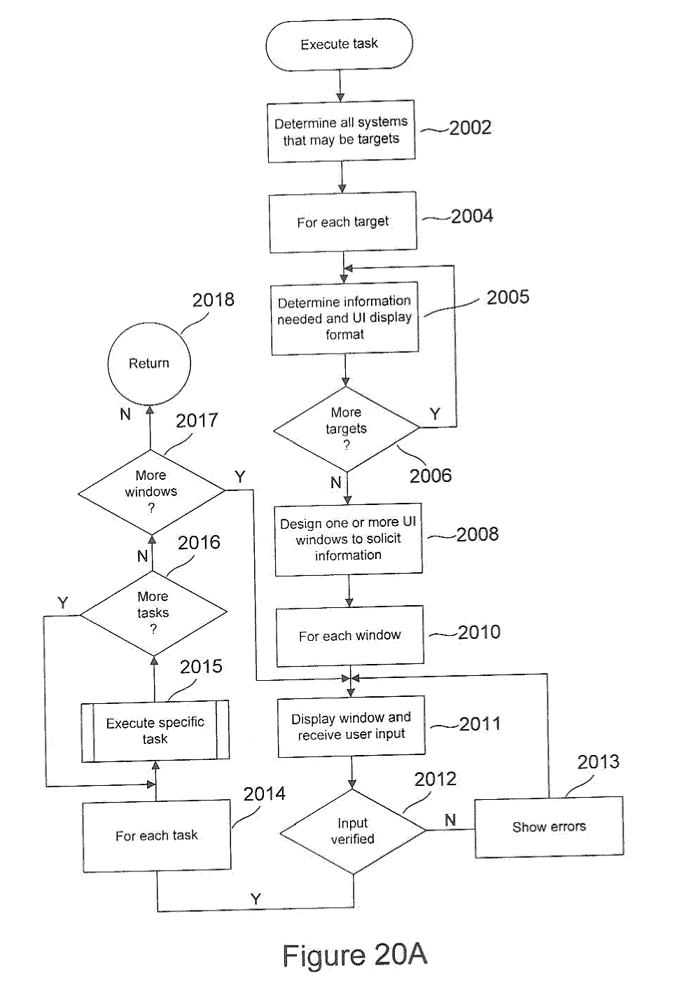

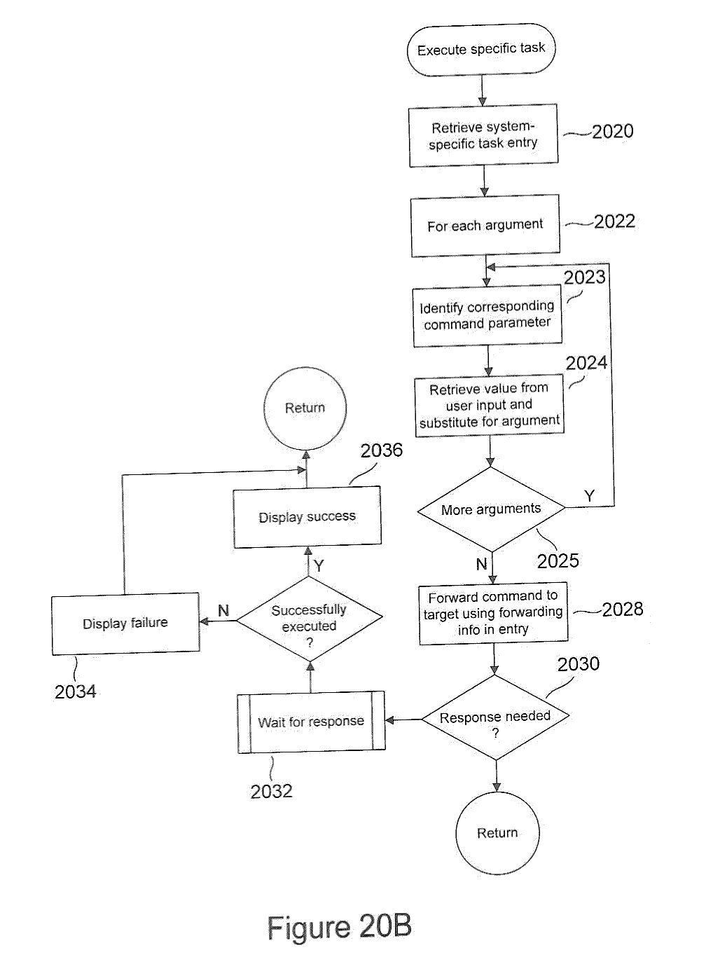

The data-driven complex-system management interface that represents one embodiment of the present invention provides, as discussed above with reference to FIGS. 15A-E, a graphical user interface that allows a system administrator or other user to direct management commands to embedded systems. The data is used to generate the complex-system management-interface windows and displays, including those shown in FIGS. 15B-E. FIGS. 20A-B provide control-flow diagrams for a routine “execute task” that constructs high-level command user-interface windows to select management tasks for which information is obtained from users and that directs target-specific commands to embedded systems according to one embodiment of the present invention. FIGS. 20A provides a control-flow diagram for the routine “execute task,” and FIG. 20B provides a control-flow diagram for the routine “execute specific task” called in step 2015 of FIG. 20A. First, in step 2002, the routine “execute task,” called from a complex-system management interface that provides a hierarchical tree of management tasks, such as that shown in FIG. 15B, determines, from the table “Commands” and the table “Targets,” all embedded systems that are potential targets for the command. Then, in the for-loop of steps 2004-2006, the routine “execute task” determines, for each potential target, using the entry for the management command in the table “Commands” and the row in the table “Targets” corresponding to the currently considered target, the information needed to be supplied by a user or a system administrator in order to construct a target-specific version of the management command for direction to the target embedded system. Once this information is collected for all possible targets, the routine “execute task,” in step 2008, designs one or more user interface windows to solicit needed information as well as to solicit indications of which potential targets management commands should be directed to. Many different designs are possible. For example, all targets of a particular type can be grouped together in a single window. When the management command can be directed to multiple targets concurrently, the interface can be configured with check lists to allow the user to select all or some subset of the targets to which to direct the management command. By contrast, if the management command can be directed to only a single target, radio buttons are displayed on the user interface to require the system administrator or user to select a single target among the potential candidate targets. The routine “execute task” uses the detailed information about parameter data types and other information about commands to construct an appropriate user interface in order to solicit appropriately formatted parameter values of appropriate data types for constructing target-specific commands. Next, in the for-loop of steps 2010-2017, the routine “execute task” displays each constructed window and receives user input from a displayed window in step 2011. In step 2012, the routine “execute task” verifies the user input, to make sure that it corresponds to the proper values for the parameters. When the input is incorrect, as detected in step 2012, the user interface indicates errors to the user and control returns to step 2011 to solicit correct user input. Otherwise, in the inner for-loop of steps 2014-2016, each task for which user input is specified in the display window is executed, via a call to the routine “execute specific task,” described below.

The routine “execute specific task,” shown in FIG. 20B, executes a target-specific management command by constructing a target-specific management command corresponding to a high-level management command and directing that target-specific command to a target embedded system. In step 2020, the system-specific command template is retrieved from the table “Target-Specific Commands.” In the for-loop of steps 2022-2025, the routine “execute specific task” retrieves a user-input value corresponding to a high-level command parameter for each argument in the system-specific command template and replaces the argument in the template with the value. Then, once the system-specific command has been prepared, the routine “execute specific task” forwards the command, in step 2028, to the target system using the communications information contained in an entry for the target system in the table “Targets.” When a response is required, as determined in step 2030, the routine “execute specific task” waits for a response from the target system, in step 2032. When the response is received, either an indication of failure 2034 or an indication of success 2036 is displayed to a user or system administrator. In alternative embodiments of the routine “execute specific task,” timeouts are employed to detect cases in which embedded systems do not respond, and target responses are logged for subsequent inspection rather than returned to users directly.

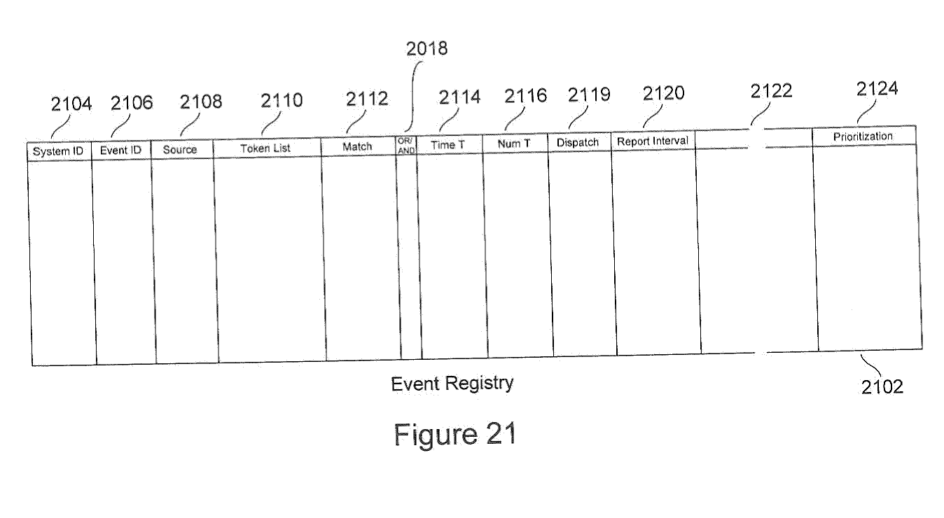

When embedded systems are monitored for event occurrence, the complex-system management interface, according to embodiments of the present invention, filters events that are returned by embedded systems to the complex-system management interface to provide event notification in a useful manner to the system console and to any other event-monitoring clients within the complex system. In addition to registering, on the embedded systems, for notification of events, the complex-system management interface maintains one or more event registries to facilitate filtering and monitoring of events. FIG. 21 illustrates a relational table “Event Registry” used in one embodiment of the present invention. The table “Event Registry” 2102 includes rows that describe event processing desired by a particular client within the complex system, such as the management console. Each row describes an event on a specific target system that the client wishes to monitor. Columns include: (1) the system ID of a target system 2104; (2) the event ID of the event that the client wishes to monitor on the target system 2106; (3) a source for event acquisition on the target system 2108; (4) a token list 2110 that indicates tokens that can be parsed from a log entry for the event; (5) match criteria 2112 that indicate which of the tokens in the token list should be present, or match particular values, in order for the event to be returned to the client; (6) a time threshold 2114; (7) a number threshold 2116; (8) an indication of whether a Boolean AND or OR of the two thresholds should be used 2118 when values for both thresholds are present; (9) a dispatch field 2118 that indicates how events are to be dispatched to the client; (10) a report-interval field 2120 that indicates how often events should be reported to the client; (11) any other such parameters 2122; and (12) a parameter that indicates various types of event prioritization with regard to the particular event 2124. The time threshold 2114 specifies that some number of the same events must be received, within a preceding time interval, before any of the events are reported. Similarly, the number threshold 2116 specifies a number of events that must be received during a preceding time interval, for the events to be reported. The AND/OR field 2118 indicates, when both types of thresholds are specified, whether they should be combined in AND or OR fashion. Many additional parameters may be specified for a particular event monitored on a particular target system. There may be a separate event registry table for each client, or, alternatively, a client column may indicate the clients for which each row applies.

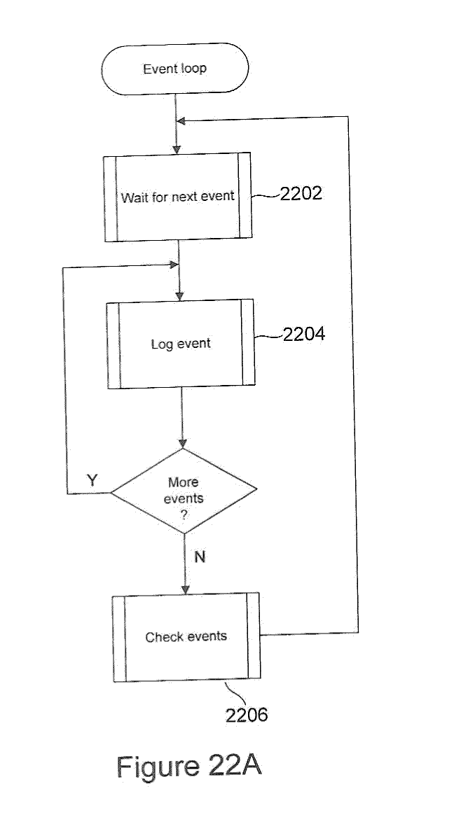

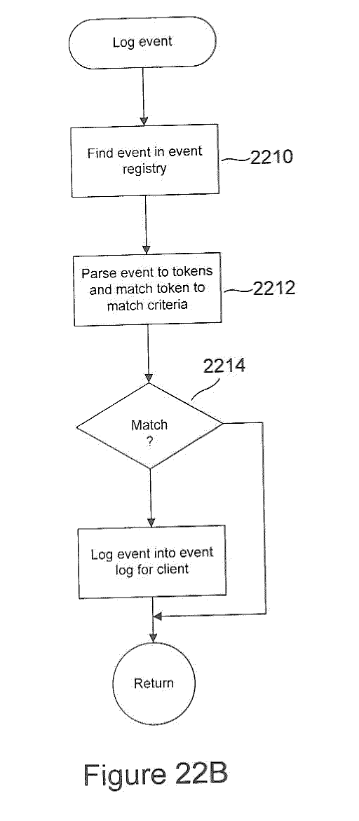

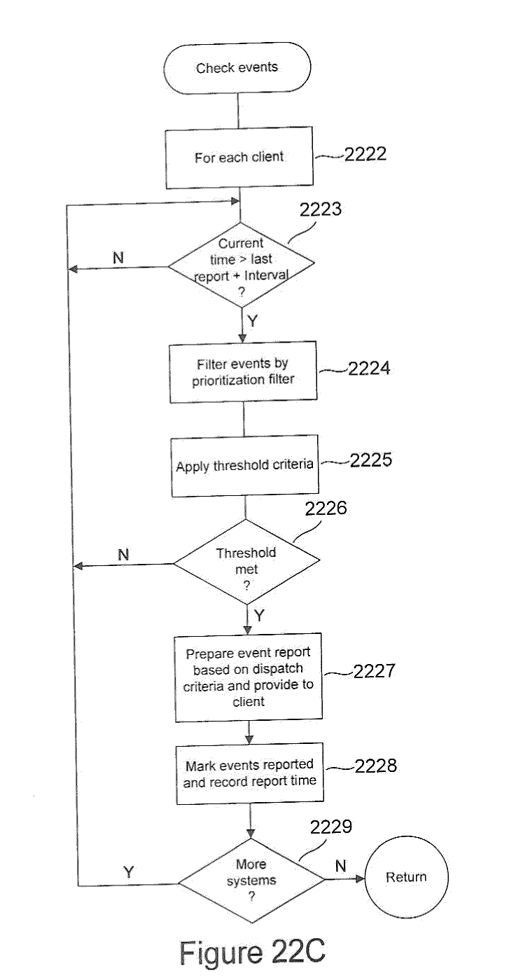

FIGS. 22A-C illustrate control-flow diagrams for event-filtering and event-reporting routines according to one embodiment of the present invention. FIG. 22A provides a control-flow diagram for a high-level event loop executed in the complex system. In step 2202, the event loop waits for a next event to be received from an embedded system. A routine “log event” is called, in step 2204, when an event is received. The routine “log event” is called for all events that have been received. Once all events have been logged, then the routine “check events” is called in step 2206 to carry out any event reporting and event-log maintenance that is needed.

FIG. 22B provides a control-flow diagram for the routine “log event,” called in step 2204 in FIG. 22A, according to embodiments of the present invention. In step 2210, the routine “log event” finds an entry for the event in the event registry, in the case that a single event registry. Otherwise, in the case of multiple event registries for multiple clients, the routine “log event” is called for each client, in an outer for-loop not shown in FIG. 22B. In step 2212, the log entry for the event is parsed in order to parse out tokens and match tokens against the match criteria specified in the event registry. If a match is detected, as determined in step 2214, then the event is logged into an event log for the client in the complex system for which the event is monitored.

FIG. 22C provides a control-flow diagram for the routine “check events” called in step 2206 of FIG. 22A. For each client, the routine “check events” determines whether or not to report events to the client, in the for-loop comprising steps 2202-2209. When the current system time is greater than a sum of the last event-reporting time for the client and the reporting interval, as determined in step 2203, then, in steps 2204 and 2205, thresholding criteria and prioritization criteria are applied to the events logged for the client, in steps 2204 and 2205, to determine whether or not there are events that meet the thresholding and prioritization criteria and therefore should be reported to the client. When the threshold criteria and other criteria are met, as determined in step 2206, then, in step 2207, an event report is prepared based on the dispatch criteria for each event, and reported events are marked as having been reported in step 2208. The dispatch criteria generally include indications of which events to report, and the prioritization criteria may filter certain events when higher-priority events have occurred.

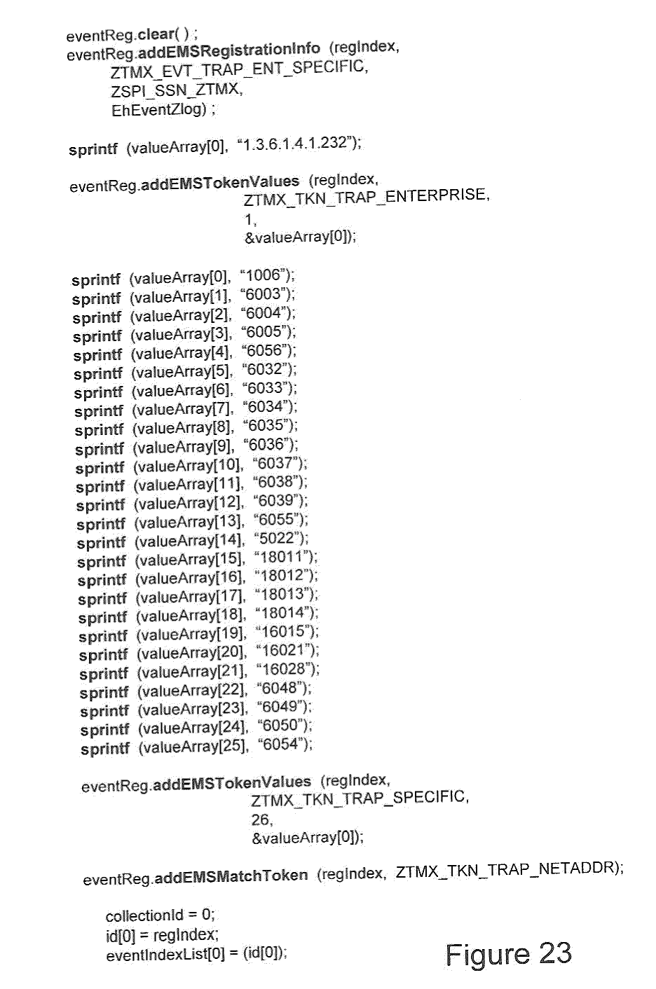

In the final 3 figures, FIGS. 23-25, code extracts from a complex-system managed according embodiments of the present invention are provided. The first two code extracts are related to event detection, and the third code extract is related to embedded-system boot.

FIG. 23 shows code within a console program used to configure event detection on a stand-alone-system component of a complex system according to one embodiment of the present invention. Essentially, an event-registration facility on the stand-alone-system component is called in order to direct event notifications to an event-collection routine for a specific set of events of interest to the console program of the complex system that includes the stand-alone-system component.

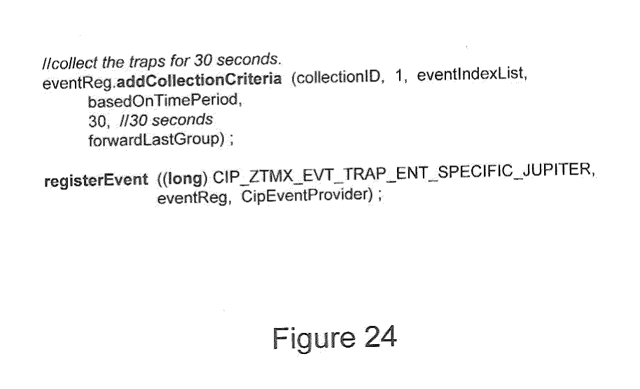

FIG. 24 shows code for detecting events on a stand-alone-system component of a complex system according to one embodiment of the present invention. Events are collected for a specified time period, and an event-collection routine developed for the stand-alone-system component can transmit the collected events, through an internal communications medium, to the console program.

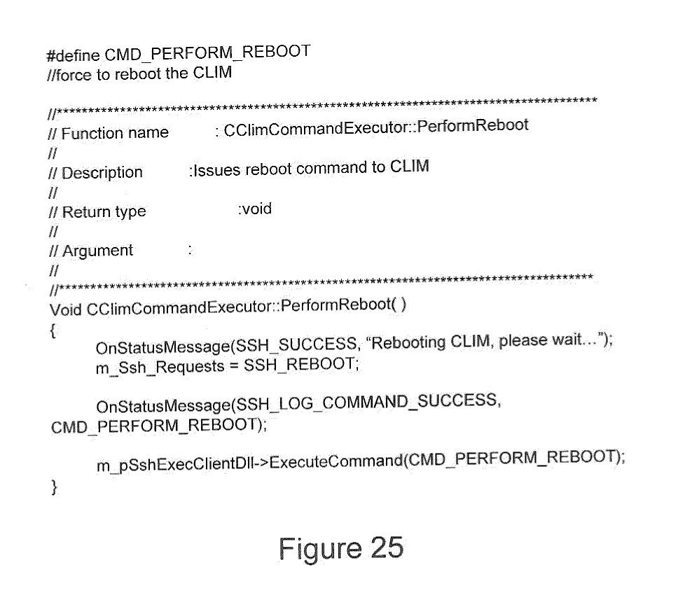

FIG. 25 shows code within a console program used to boot a stand-alone-system component of a complex system according to one embodiment of the present invention. A shell command is directed to an IM that directs the iLO interface to boot the server used to implement the IM.

Although the present invention has been described in terms of particular embodiments, it is not intended that the invention be limited to these embodiments. Modifications will be apparent to those skilled in the art. For example, system-management approaches of the present invention may be employed for management of many different types of stand-alone systems incorporated as components or subsystems in complex systems. The stand-alone systems may be connected with a management console or other management component of the complex system by any of various different types of internal communications media. The stand-alone systems may employ in of various different operating systems, and may include an enormous number of different types of internal subcomponents. In general, low-level facilities within the stand-alone systems are used for obtaining information, launching tasks, and other activities and operations needed by the management program of the complex system that includes the stand-alone systems as components. When possible, web-based management interfaces already provided by the stand-alone systems may be employed within the context of the complex-system interface, to avoid needing to develop special-purpose interfaces for the same purposes. Various information and protocol exchanges needed for use of the pre-existing facilities and management interfaces in the stand-alone systems are provided by the complex-system management program, so that system administrators need not supply the information and concern themselves with details of the protocol exchanges used to manage the stand-alone systems in the context of overall system management.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system-management component of a complex system that includes stand-alone-system components, the system-management component comprising:
an internal-communications medium that interconnects components of the complex system, including the stand-alone-system components;
management components, incorporated in components of the complex system other than the stand-alone-system components, that communicate with the system-management component through the internal-communications medium;
a management program that executes within the system-management component to provide a complex-system management interface and that interfaces to the management components of the components of the complex system other than the stand-alone-system components; and
routines within the management program that execute on the system-management component and that interface through the internal-communications medium to native management facilities of the stand-alone-system components to adapt the management program in order to obtain information from, and launch operations on, the stand-alone-system components.

2. The system-management component of claim 1
wherein the complex-system management interface provided by the management program includes
a complex-system booting facility,
a complex-system-component-health-monitoring facility,
an event-detection and event-notification facility, and
a configuration and control facility; and
wherein the native facilities of the stand-alone-system components include:
an event-registration facility,
an external boot interface, and
native configuration and control commands.

3. The system-management component of claim 2 wherein the complex-system booting facility provided through the complex-system management interface directs a boot command to the external boot interface of a stand-alone-system component.

4. The system-management component of claim 2 wherein the complex-system-component-health-monitoring facility provided through the complex-system management interface employs the event-registration facility of a stand-alone-system component to configure a health-monitoring-related collection routine that executes on the stand-alone-system component to collect health-monitoring-related events and forward the collected health-monitoring-related events to the management program that executes within the system-management component.

5. The system-management component of claim 2 wherein the complex-system event-detection and event-notification facility provided through the complex-system management interface employs the event-registration facility of a stand-alone-system component to configure an event-collection routine that executes on the stand-alone-system component to collect events and forward the collected events to the management program that executes within the system-management component.

6. The system-management component of claim 2 wherein the event-detection and event-notification facility includes an event-filtering and event-reporting component that allows a user to specify which events from each target system and under what circumstance the events from each target system are to be reported to the user.

7. The system-management component of claim 7 wherein the event-detection and event-notification facility provides an interface through which a user can indicate the event types that the user wishes to receive reports for, from each embedded subsystem, by specifying event types, token-presence and token-matching criteria for tokens parsed from event-log entries for the events, and event-occurrence thresholds that specify one or both of threshold numbers and threshold frequencies of event occurrence for event reporting for specified event types.

8. The system-management component of claim 2 wherein the event-detection and event-notification facility includes an event-filtering and event-reporting component that provides an application-programming interface to control which events from each target system and under what circumstance the events from each target system are to be reported by the event-detection and event-notification facility.

9. The system-management component of claim 8 wherein the application-programming interface provides for receiving, from an application program, indications of the event types for which reports are to be prepared, for specified embedded subsystems, wherein the event types are indicated by specification of event types, token-presence and token-matching criteria for tokens parsed from event-log entries for the events, and event-occurrence thresholds that specify one or both of threshold numbers and threshold frequencies of event occurrence for event reporting for specified event types.

10. The system-management component of claim 2 wherein the complex-system management interface is data driven, with command-selection and parameter-input interfaces generated dynamically from descriptions of the embedded systems, high-level management commands, and native-embedded-system commands stored in a database within the complex system.

11. The system-management component of claim 10 wherein descriptions of the embedded systems, high-level management commands, and native-embedded-system commands stored in a database within the complex system are created, updated, and deleted by user input received through one or more of:
a graphical user interface;
a text file;
an XML file; or
a formatted file.

12. The system-management component of claim 10 wherein a management command is selected for execution and directed to specific target embedded systems by a user through the complex-system management interface, which uses parameters specified for a high-level management command to generate a native-embedded-system command for each target embedded system by substituting, for each argument within a template for the native-embedded-system command, a user-specified value for a corresponding high-level-command parameter.

13. The system-management component of claim 10 wherein the complex-system management interface automatically determines all possible target embedded systems to which a high-level command can be directed using the descriptions of the embedded systems, high-level management commands, and native-embedded-system commands stored in the database within the complex system, and displays the possible target embedded systems to a user who has selected the high-level command for execution.

14. A method for managing a complex system that includes stand-alone-system components and an internal-communications medium that interconnects components of the complex system, including the stand-alone-system components, the method comprising:
incorporating management components, in components of the complex system other than the stand-alone-system components, that communicate with the system-management component through the internal-communications medium; and
carrying out management tasks to manage the complex system, provided by a complex-system management interface, executed by a management program that executes within a system-management component of the complex system that interfaces to the management components of the components of the complex system other than the stand-alone-system components and that executes routines which execute on the system-management component and which interface through the internal-communications medium to native management facilities of the stand-alone-system components to adapt the management program in order to obtain information from, and launch operations on, the stand-alone-system components.

15. The method of claim 14
wherein the complex-system management interface provided by the management program includes
a complex-system booting facility,
a complex-system-component-health-monitoring facility,
an event-detection and event-notification facility, and
a configuration and control facility; and
wherein the native facilities of the stand-alone-system components include:
an event-registration facility,
an external boot interface, and
native configuration and control commands.

16. The method of claim 15 wherein the complex-system booting facility provided through the complex-system management interface directs a boot command to the external boot interface of a stand-alone-system component.

17. The method of claim 15 wherein the complex-system-component-health-monitoring facility provided through the complex-system management interface employs the event-registration facility of a stand-alone-system component to configure a health-monitoring-related collection routine that executes on the stand-alone-system component to collect health-monitoring-related events and forward the collected health-monitoring-related events to the management program that executes within the system-management component.

18. The method of claim 15 wherein the complex-system event-detection and event-notification facility provided through the complex-system management interface employs the event-registration facility of a stand-alone-system component to configure an event-collection routine that executes on the stand-alone-system component to collect events and forward the collected events to the management program that executes within the system-management component.

19. The method of claim 15 wherein the event-detection and event-notification facility includes an event-filtering and event-reporting component that allows a user to specify which events from each target system and under what circumstance the events from each target system are to be reported to the user.

20. The s method of claim 15
wherein the complex-system management interface is data driven, with command-selection and parameter-input interfaces generated dynamically from descriptions of the embedded systems, high-level management commands, and native-embedded-system commands stored in a database within the complex system;
wherein descriptions of the embedded systems, high-level management commands, and native-embedded-system commands stored in a database within the complex system are created, updated, and deleted by user input received through one or more of
a graphical user interface,
a text file,
an XML file, or
a formatted file; and
wherein a management command is selected for execution and directed to specific target embedded systems by a user through the complex-system management interface, which uses parameters specified for a high-level management command to generate a native-embedded-system command for each target embedded system by substituting, for each argument within a template for the native-embedded-system command, a user-specified value for a corresponding high-level-command parameter.
